(19) United States
(12) Patent Application Publication
(10) Pub. No.: US 2025/0081191 A1
(43) Pub. Date: Mar. 6, 2025

(54) DATA TRANSMISSION METHOD AND APPARATUS

(71) Applicant: HUAWEI TECHNOLOGIES CO., LTD., Shenzhen (CN)

(72) Inventors: Xiuqiang XU, Shanghai (CN); Yan CHEN, Ottawa (CA); Lei WANG, Shanghai (CN)

(21) Appl. No.: 18/948,619

(22) Filed: Nov. 15, 2024

Related U.S. Application Data
(63) Continuation of application No. PCT/CN2023/089483, filed on Apr. 20, 2023.

(30) Foreign Application Priority Data
May 20, 2022 (CN) 202210553022.5

(51) Int. Cl. H04W 72/1268; H04W 72/542

(52) U.S. Cl. CPC H04W 72/1268; H04W 72/542

(57) ABSTRACT

A method includes: a first terminal apparatus receives first uplink grant information, where a time-frequency resource corresponding to the first uplink grant information is used for uplink transmission of a second terminal apparatus; the first terminal apparatus determines a beam direction based on the first uplink grant information; and when the beam direction meets a preset condition, the first terminal apparatus sends uplink data on the time-frequency resource.

### CROSS-REFERENCE TO RELATED APPLICATIONS

This application is a continuation of International Application No. PCT/CN2023/089483, filed on Apr. 20, 2023, which claims priority to Chinese Patent Application No.202210553022.5, filed on May 20, 2022. The disclosures of the aforementioned applications are hereby incorporated by reference in their entireties.

### TECHNICAL FIELD

This disclosure relates to the field of mobile communication technologies, and in particular, to a data transmission method and apparatus.

### BACKGROUND

In a mobile communication system such as a 5th generation mobile communication technology (5G) new radio (NR) system, a base station configures, for a terminal by using a terminal (e.g. user equipment, UE)-specific (UE-specific) RRC message, a grant-free (GF) resource used for inactive-state transmission (for example, small data transmission). For example, the grant-free resource includes a periodic time-frequency resource, a demodulation reference signal (DMRS) resource, and a transmission parameter such as a modulation and coding scheme (MCS). When the terminal has an uplink data packet transmission requirement, the terminal may send data by using the grant-free resource. When the time-frequency resource is shared by a plurality of terminals, the base station may distinguish between respective grant-free resources of the terminals by using DMRS resources such as DMRS ports or DMRS sequences. For example, different terminals receive grant-free resource configurations by using different DMRS ports or sequences.

When configuring the grant-free resource, the base station needs to consider all terminals whose service types are suitable for grant-free transmission in a cell. The terminals may be completely scattered in the cell. This means that the base station needs to configure associated time-frequency resources and DMRS resources for all or most beam directions (such as SSBs). As a result, time-frequency resources mapped to a same beam direction have a large time interval. Therefore, in a current grant-free resource configuration manner, a quantity of terminal devices that perform multiplexing transmission on a same time-frequency resource is limited, and it is difficult to meet a terminal multiplexing transmission requirement brought by an increasing quantity of terminals.

### SUMMARY

This disclosure provides a data transmission method and apparatus, to increase a quantity of terminal devices that perform multiplexing transmission on a same time-frequency resource.

According to a first aspect, this disclosure provides a data transmission method, to increase a quantity of terminal devices that perform multiplexing transmission on a same time-frequency resource. The method may be implemented by a first terminal apparatus. For example, the first terminal apparatus is a terminal device (which may be referred to as a terminal device corresponding to the first terminal apparatus) or a component in the terminal device. The component in this disclosure is, for example, at least one of a processor, a transceiver, a processing module, or a transceiver module. In this disclosure, the terminal device corresponding to the first terminal apparatus may be a secondary terminal. For example, an execution body is the first terminal apparatus. The method may be implemented by using the following steps: The first terminal apparatus receives first uplink grant information. A time-frequency resource corresponding to the first uplink grant information is used for uplink transmission of a second terminal apparatus, in other words, a terminal device corresponding to the second terminal apparatus is a primary terminal. The first terminal apparatus may further determine a beam direction based on the first uplink grant information. When the beam direction meets a preset condition, the first terminal apparatus may send uplink data on the time-frequency resource. Because the time-frequency resource corresponding to the first uplink grant information is used for the uplink transmission of the second terminal apparatus, in other words, the time-frequency resource corresponding to the first uplink grant information is allocated by a network device to the second terminal apparatus, and the first terminal apparatus may perform uplink transmission by using the time-frequency resource when determining that the beam direction meets the preset condition, the network device does not need to separately allocate a time-frequency resource to the terminal device corresponding to the first terminal apparatus, so that a quantity of terminal devices that perform multiplexing transmission on a same time-frequency resource can be increased, thereby improving a multiplexing capability of a communication system.

In some embodiments, when the beam direction does not meet the preset condition, the first terminal apparatus may alternatively skip sending the uplink data on the time-frequency resource. Therefore, when determining that the beam direction does not meet the preset condition, the first terminal apparatus skips sending the uplink data on the time-frequency resource, to avoid a transmission failure and reduce interference caused to transmission of the second terminal apparatus.

In some embodiments, the preset condition includes at least one of the following: a signal measurement value corresponding to the beam direction meets a threshold condition; and a beam direction of the first terminal apparatus includes the beam direction. Therefore, the preset condition may be flexibly set, so that the first terminal apparatus sends the uplink data based on the time-frequency resource in a proper condition, to improve transmission reliability when the first terminal apparatus performs transmission by using the resource.

In some embodiments, the first terminal apparatus may receive the first uplink grant information from the second terminal apparatus; or the first terminal apparatus may receive the first uplink grant information from a network device. Therefore, the first terminal apparatus may flexibly obtain the first uplink grant information, to meet transmission requirements in different scenarios.

In some embodiments, the first uplink grant information includes indication information of a reference signal associated with the beam direction or a beam direction identifier, and the first terminal apparatus may determine the beam direction based on the indication information of the reference signal or the beam direction identifier. In this design, the first uplink grant information may explicitly indicate the beam direction, so that the first terminal apparatus can flexibly and accurately determine the beam direction.

In some embodiments, the first terminal apparatus determines the beam direction based on at least one of an RNTI, a CORESET, search space, or a signaling format used to receive the first uplink grant information. In this design, the first uplink grant information may implicitly indicate the beam direction, so that the first terminal apparatus can flexibly and accurately determine the beam direction.

In some embodiments, the first uplink grant information further includes indication information of a transmission resource and/or indication information of a transmission parameter, the transmission resource and/or the transmission parameter are/is used by the first terminal apparatus to send the uplink data, and the transmission resource includes the time-frequency resource. In this design, the first uplink grant information may explicitly indicate the transmission resource and/or the transmission parameter, so that the first terminal apparatus can flexibly and accurately determine the transmission resource and/or the transmission parameter, to send the uplink data based on the transmission resource and/or the transmission parameter.

In some embodiments, the first terminal apparatus may further determine a transmission resource and/or a transmission parameter based on the at least one of the RNTI, the CORESET, the search space, or the signaling format used to receive the first uplink grant information, where the transmission resource and/or the transmission parameter are/is used by the first terminal apparatus to send the uplink data, and the transmission resource includes the time-frequency resource. In this design, the first uplink grant information may implicitly indicate the transmission resource and/or the transmission parameter, so that the first terminal apparatus can flexibly and accurately determine the transmission resource and/or the transmission parameter, to send the uplink data based on the transmission resource and/or the transmission parameter.

In some embodiments, when the first uplink grant information is from the network device, the first uplink grant information further includes indication information indicating that the first terminal apparatus is allowed to send the uplink data to the network device. In this design, when the first uplink grant information includes the indication information indicating that the first terminal apparatus is allowed to send the uplink data to the network device, the first terminal apparatus may send the uplink data based on the first uplink grant information from the network device. In another case, the first terminal apparatus skips sending the uplink data based on the first uplink grant information, to reduce transmission interference.

In some embodiments, the first uplink grant information is included in DCI. Therefore, the first terminal apparatus may monitor a PDCCH, to receive the first uplink grant information. For example, the first terminal apparatus may receive, based on the at least one of the RNTI, the CORESET, the search space, or the signaling format used to receive the first uplink grant information, the first uplink grant information carried in the DCI, to improve efficiency of receiving the first uplink grant information.

According to a second aspect, this disclosure provides a data transmission method, to increase a quantity of terminal devices that perform multiplexing transmission on a same time-frequency resource. The method may be implemented by a second terminal apparatus. For example, the second terminal apparatus is a terminal device (which may be referred to as a terminal device corresponding to the second terminal apparatus) or a component in the terminal device. The component in this disclosure is, for example, at least one of a processor, a transceiver, a processing module, or a transceiver module. In this disclosure, the terminal device corresponding to the second terminal apparatus may be a primary terminal. For example, an execution body is the second terminal apparatus. The method may be implemented by using the following steps: The second terminal apparatus receives second uplink grant information from a network device; and the second terminal apparatus sends first uplink grant information to a first terminal apparatus based on the second uplink grant information, where a time-frequency resource corresponding to the first uplink grant information is used for uplink transmission of the second terminal apparatus, and the first uplink grant information includes indication information of a reference signal associated with a beam direction or a beam direction identifier. Therefore, the second terminal apparatus may receive the second uplink grant information from the network device, and send the first uplink grant information to the first terminal apparatus, so that the first terminal apparatus has an opportunity to send uplink data to the network device based on the first uplink grant information. Therefore, the network device does not need to separately allocate a time-frequency resource to a terminal device corresponding to the first terminal apparatus, and the quantity of terminal devices that perform multiplexing transmission on the same time-frequency resource can be increased, thereby improving a multiplexing capability of a communication system.

In some embodiments, the first uplink grant information further includes indication information of a transmission resource and/or indication information of a transmission parameter, the transmission resource and/or the transmission parameter are/is used by the first terminal apparatus to send the uplink data, and the transmission resource includes the time-frequency resource.

In some embodiments, the second uplink grant information is included in downlink control information (DCI).

According to a third aspect, this disclosure provides a data transmission method, to increase a quantity of terminal devices that perform multiplexing transmission on a same time-frequency resource. The method may be implemented by a network device or a component in the network device. The component in this disclosure is, for example, at least one of a processor, a transceiver, a processing module, or a transceiver module. For example, an execution body is the network device. The method may be implemented by using the following steps: The network device determines first uplink grant information, where a time-frequency resource corresponding to the first uplink grant information is used for uplink transmission of a second terminal apparatus;

and the network device sends the first uplink grant information. The first terminal apparatus may send uplink data to the network device based on the time-frequency resource corresponding to the first uplink grant information. Therefore, the network device does not need to separately allocate a time-frequency resource to a terminal device corresponding to the first terminal apparatus, and the quantity of terminal devices that perform multiplexing transmission on the same time-frequency resource can be increased, thereby improving a multiplexing capability of a communication system.

The first uplink grant information in the third aspect may be understood as the first uplink grant information and/or the second uplink grant information in the first aspect or the second aspect.

In some embodiments, the first uplink grant information includes indication information of a reference signal associated with a beam direction or a beam direction identifier.

In some embodiments, at least one of an RNTI, a CORESET, search space, or a signaling format used to send the first uplink grant information is further used to determine a beam direction.

In some embodiments, the first uplink grant information further includes indication information of a transmission resource and/or indication information of a transmission parameter, and the transmission resource includes the time-frequency resource.

In some embodiments, the at least one of the RNTI, the CORESET, the search space, or the signaling format used to send the first uplink grant information is further used to determine a transmission resource and/or a transmission parameter, and the transmission resource includes the time-frequency resource.

According to a fourth aspect, a data transmission apparatus is provided. The apparatus may implement the method according to some embodiments of the first aspect. The apparatus has a function of the first terminal apparatus. The apparatus is, for example, a terminal device corresponding to the first terminal apparatus, or a function module in the terminal device.

Alternatively, the apparatus may implement the method according to the second aspect and some embodiments of the second aspect. The apparatus has a function of the second terminal apparatus. The apparatus is, for example, a terminal device corresponding to the second terminal apparatus, or a function module in the terminal device.

Alternatively, the apparatus may implement the method according to the third aspect and some embodiments of the third aspect. The apparatus has a function of the network device. The apparatus is, for example, the network device, or a function module in the network device.

In some embodiments, the apparatus may include modules that are in one-to-one correspondence with the methods/operations/steps/actions described in the first aspect, the second aspect, or the third aspect. The modules may be hardware circuits or software, or may be implemented by a combination of the hardware circuits and the software. In some embodiments, the apparatus includes a processing unit (sometimes also referred to as a processing module) and a transceiver unit (sometimes also referred to as a transceiver module). The transceiver unit can implement a sending function and a receiving function. When the transceiver unit implements the sending function, the transceiver unit may be referred to as a sending unit (sometimes also referred to as a sending module). When the transceiver unit implements the receiving function, the transceiver unit may be referred to as a receiving unit (sometimes also referred to as a receiving module). The sending unit and the receiving unit may be a same function module, the function module is referred to as a transceiver unit, and the function module can implement the sending function and the receiving function. Alternatively, the sending unit and the receiving unit may be different function modules, and the transceiver unit is a general term for the function modules.

For example, when the apparatus is configured to perform the method described in the first aspect, the apparatus may include a transceiver module and a processing module. The transceiver module may be configured to receive first uplink grant information. The processing module may be configured to determine a beam direction based on the first uplink grant information. The transceiver module may be further configured to: when the beam direction meets a preset condition, send uplink data on a time-frequency resource. For the first uplink grant information, refer to the descriptions in the first aspect.

In some embodiments, the transceiver module may be further configured to: when the beam direction does not meet the preset condition, skip sending the uplink data on the time-frequency resource. For the preset condition, refer to the descriptions in the first aspect.

In addition, optionally, the transceiver module may be configured to receive the first uplink grant information from the network device or the second terminal apparatus.

In some embodiments, when the first uplink grant information includes indication information of a reference signal associated with the beam direction or a beam direction identifier, the processing module may further determine the beam direction based on the indication information of the reference signal or the beam direction identifier. Alternatively, the processing module may further determine the beam direction based on at least one of a radio network temporary identifier (RNTI), a control-resource set (CORESET), search space, or a signaling format used to receive the first uplink grant information.

In some embodiments, the processing module may further determine a transmission resource and/or a transmission parameter based on the at least one of the RNTI, the CORESET, the search space, or the signaling format used to receive the first uplink grant information, where the transmission resource and/or the transmission parameter are/is used by the first terminal apparatus to send the uplink data, and the transmission resource includes the time-frequency resource.

For example, when the apparatus is configured to perform the method described in the second aspect, the apparatus may include a transceiver module and a processing module. The transceiver module may be configured to receive second uplink grant information from the network device, and may be further configured to send first uplink grant information to the first terminal apparatus based on the second uplink grant information. In some embodiments, the processing module may be configured to generate the first uplink grant information based on the second uplink grant information. For the first uplink grant information and the second uplink grant information, refer to the descriptions in the first aspect or the second aspect.

For example, when the apparatus is configured to perform the method described in the third aspect, the apparatus may include a transceiver module and a processing module. The processing module may be configured to determine first uplink grant information, and the transceiver module may be configured to send the first uplink grant information. For the first uplink grant information, refer to the descriptions of the first uplink grant information in the third aspect.

For another example, the apparatus includes a processor, coupled to a memory, and configured to execute instructions in the memory, to implement the method in the first aspect, the second aspect, or the third aspect. Optionally, the apparatus further includes another component, for example, an antenna, an input/output module, and an interface. The component may be hardware, software, or a combination of software and hardware.

According to a fifth aspect, a computer-readable storage medium is provided. The computer-readable storage medium is configured to store a computer program or instructions, and when the computer-readable storage medium is run, the method in any one of the first aspect to the third aspect is implemented.

According to a sixth aspect, a computer program product including instructions is provided. When the computer program product runs on a computer, the method in any one of the first aspect to the third aspect is implemented.

According to a seventh aspect, a chip system is provided. The chip system includes a logic circuit (which may alternatively be understood as that the chip system includes a processor, and the processor may include a logic circuit and the like), and may further include an input/output interface. The input/output interface may be configured to receive a message, or may be configured to send a message. For example, when the chip system is configured to implement a function of the first terminal apparatus, the input/output interface may be configured to receive first uplink grant information. The input/output interface may be a same interface, that is, a same interface can implement both a sending function and a receiving function. Alternatively, the input/output interface includes an input interface and an output interface. The input interface is configured to implement a receiving function, that is, configured to receive a message. The output interface is configured to implement a sending function, that is, configured to send a message. The logic circuit may be configured to perform an operation other than a receiving/sending function in the first aspect to the third aspect. The logic circuit may be further configured to transmit a message to the input/output interface, or receive a message from another communication apparatus through the input/output interface. The chip system may be configured to implement the method in any one of the first aspect to the third aspect. The chip system may include a chip, or may include a chip and another discrete component.

Optionally, the chip system may further include a memory, and the memory may be configured to store instructions. The logic circuit may invoke the instructions stored in the memory to implement a corresponding function.

According to an eighth aspect, a communication system is provided. The communication system may include a first terminal apparatus and a network device. The first terminal apparatus may be configured to perform the method according to the first aspect, and the network device may be configured to perform the method according to the third aspect.

Optionally, the communication system may further include a second terminal apparatus, and the second terminal apparatus may be configured to perform the method according to the second aspect.

For technical effects brought by the second aspect to the eighth aspect, refer to the descriptions of the first aspect. Details are not described herein again.

### BRIEF DESCRIPTION OF DRAWINGS

FIG. 1 is a diagram of an architecture of a wireless communication system according to this disclosure;

FIG. 2a is a diagram of an architecture of a protocol stack of a wireless communication system;

FIG. 2b is a diagram of an architecture of a protocol stack of another wireless communication system;

FIG. 3 is a schematic flowchart of RRC state switching;

FIG. 4 is a schematic flowchart of a random access method;

FIG. 5 is a schematic flowchart of another random access method;

FIG. 6 is a diagram of a relationship between a beam and a spatial direction according to this disclosure;

FIG. 7 is a diagram of a relationship between a beam and a transmission resource according to this disclosure;

FIG. 8 is a schematic flowchart of a communication method according to this disclosure;

FIG. 9 is a diagram of a structure of another communication method according to this disclosure;

FIG. 10 is a diagram of a structure of another communication method according to this disclosure;

FIG. 11 is a diagram of a structure of a communication apparatus according to this disclosure;

FIG. 12 is a diagram of a structure of another communication apparatus according to this disclosure; and

FIG. 13 is a diagram of a structure of another communication apparatus according to this disclosure.

### DESCRIPTION OF EMBODIMENTS

Embodiments of this disclosure provide a data transmission method and apparatus. The method and the apparatus are based on a same inventive concept. Because problem-resolving principles of the method and the apparatus are similar, mutual reference may be made to implementations of the apparatus and the method, and repeated parts are not described. In descriptions of embodiments of this disclosure, the term “and/or” describes an association relationship between associated objects, and indicates that three relationships may exist. For example, A and/or B may indicate the following three cases: Only A exists, both A and B exist, and only B exists. The character “/” generally indicates an “or” relationship between the associated objects. In this disclosure, “at least one” means one or more, and “a plurality of” means two or more. In addition, it should be understood that in the descriptions of this disclosure, terms such as “first” and “second” are merely used for distinguishing and description, but should not be understood as indicating or implying relative importance, or should not be understood as indicating or implying a sequence.

The data transmission method provided in embodiments of this disclosure may be applied to a 4th generation (4G) communication system, for example, a long term evolution (LTE) communication system, or may be applied to a 5th generation (5G) communication system, for example, a 5G new radio (NR) communication system, or applied to various future communication systems, for example, a 6th generation (6G) communication system. The method provided in embodiments of this disclosure may be further applied to a Bluetooth system, a Wi-Fi system, a LoRa system, or an internet of vehicles system. The method provided in embodiments of this disclosure may be further applied to a satellite communication system. The satellite communication system may be integrated with the foregoing communication system.

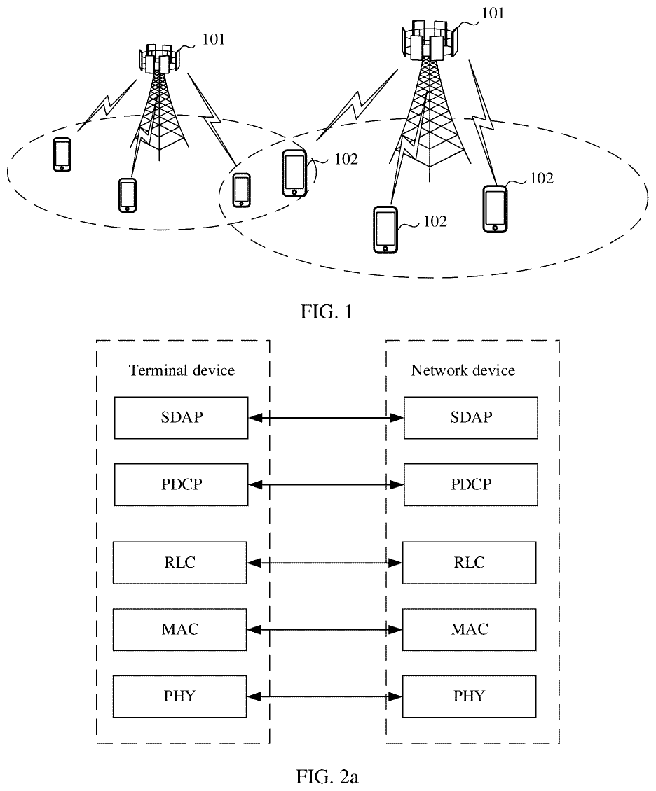

For ease of understanding of embodiments of this disclosure, an application scenario used in this disclosure is described by using a communication system architecture shown in FIG. 1 as an example. As shown in FIG. 1, a communication system 100 includes a network device 101 and a terminal device 102. The apparatus provided in embodiments of this disclosure may be used in the network device 101 or the terminal device 102. It may be understood that FIG. 1 shows only one communication system architecture to which embodiments of this disclosure may be applied. In some embodiments, the communication system architecture may alternatively include another device.

The network device 101 is a node in a radio access network (RAN), and may also be referred to as a base station or a RAN node (or device). Currently, some examples of the network device 101 are: a gNB/NR-NB, a transmission reception point (TRP), an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), a wireless fidelity (Wi-Fi) access point (AP), a satellite device, a network device in a 5G communication system, and a network device in a communication system in the future. Alternatively, the network device 101 may be another device that has a network device function. For example, the network device 101 may alternatively be a device that functions as a network device in device to device (D2D) communication, internet of vehicles communication, or machine-to-machine communication. Alternatively, the network device 101 may be a network device in a future communication system.

In some deployments, the gNB may include a central unit (CU) and a DU. The gNB may further include a radio unit (RU). The CU implements some functions of the gNB, and the DU implements some functions of the gNB. For example, the CU implements functions of a radio resource control (RRC) layer and a packet data convergence protocol (PDCP) layer, and the DU implements functions of a radio link control (RLC) layer, a media access control (MAC) layer, and a physical (PHY) layer. Information at the RRC layer eventually becomes information at the PHY layer, or is converted from the information at the PHY layer. Therefore, in the architecture, higher layer signaling such as RRC layer signaling or PHCP layer signaling may also be considered as being sent by the DU or sent by the DU and the RU. It may be understood that the network device may be a CU node, a DU node, or a device including a CU node and a DU node. In addition, the CU may be classified as a network device in an access network RAN, or the CU may be classified as a network device in a core network CN. This is not limited herein.

The terminal device 102 may also be referred to as user equipment (UE), a mobile station (, MS), a mobile terminal (MT), or the like, and is a device that provides a user with voice or data connectivity, or may be an internet of things device. For example, the terminal device includes a handheld device, a vehicle-mounted device, or the like that has a wireless connection function. Currently, the terminal device may be a mobile phone, a tablet computer, a laptop computer, a palmtop computer, a mobile internet device (MID), a wearable device (for example, a smartwatch, a smart band, or a pedometer), a vehicle-mounted device (for example, a car, a bicycle, an electric car, an airplane, a ship, a train, or a high-speed rail), a virtual reality (VR) device, an augmented reality (AR) device, a wireless terminal in industrial control, a smart household device (for example, a refrigerator, a television, an air conditioner, or a meter), an intelligent robot, workshop equipment, a wireless terminal in self driving, a wireless terminal in remote surgery, a wireless terminal in a smart grid, a wireless terminal in transportation safety, a wireless terminal in a smart city, a wireless terminal in a smart home, a flight device (for example, an intelligent robot, a hot air balloon, an uncrewed aerial vehicle, or an airplane), or the like. The terminal device may alternatively be another device having a terminal function. For example, the terminal device may alternatively be a device that functions as a terminal in D2D communication. A terminal device that has a wireless receiving/sending function and a chip that may be disposed in the terminal device are collectively referred to as the terminal device in this disclosure.

With reference to the communication system shown in FIG. 1, the following describes in detail the data transmission method provided in embodiments of this disclosure.

To better understand solutions provided in embodiments of this disclosure, the following first describes some terms, concepts, or procedures in embodiments of this disclosure.

First, a status of the terminal device is described.

As shown in FIG. 2a, a user plane protocol stack for communication between the terminal device and the network device includes a service data adaptation protocol (SDAP) layer, a packet data convergence protocol (PDCP) layer, a radio link control (RLC) layer, a media access control (MAC) layer, and a physical (PHY) layer.

As shown in FIG. 2b, a control plane protocol stack for communication between the terminal device and the network device includes a non-access stratum (NAS), a radio resource control (RRC) layer, a PDCP layer, an RLC layer, a MAC layer, and a PHY layer.

For the RRC layer, there are several RRC states of the terminal device: an RRC idle (RRC_IDLE) state, an RRC inactive (RRC_INACTIVE) state, and an RRC connected (RRC_CONNECTED) state. When the terminal device has set up an RRC connection, the terminal device is in the RRC_CONNECTED state or the RRC_INACTIVE state. If the terminal device does not set up an RRC connection, the terminal device is in the RRC IDLE state. The RRC_INACTIVE state is a state introduced for the terminal device in the 5G NR communication system. The RRC_INACTIVE state is mainly for a case in which “a terminal device that performs infrequent data transmission is usually kept in the RRC_INACTIVE state by a network”.

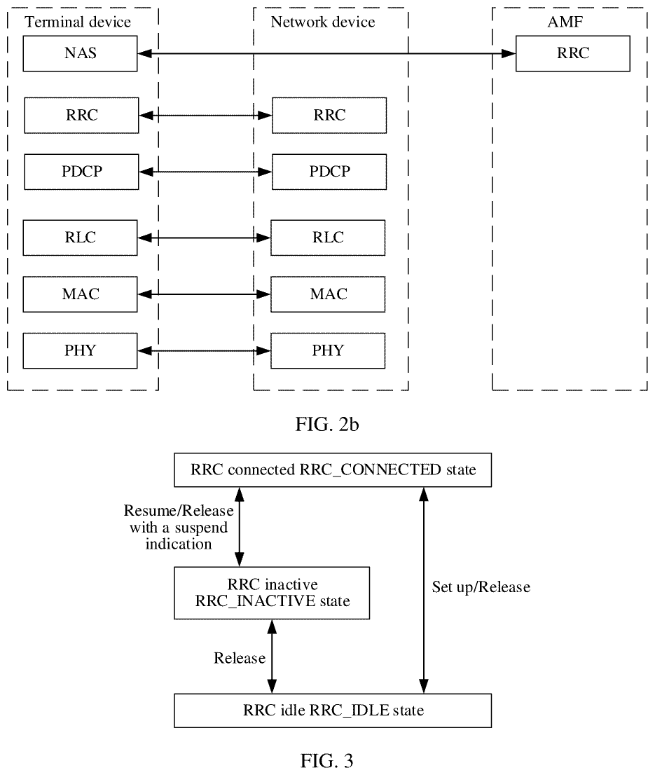

The terminal device performs different operations in different RRC states. A process of switching among the three states is shown in FIG. 3. The terminal device is initially in the RRC_IDLE state. When the terminal device needs to perform data transmission, the terminal device performs a random access process to set up an RRC connection to the network device, and enters the RRC_CONNECTED state. After entering the RRC_CONNECTED state, the terminal device starts to perform data transmission. To set up the RRC connection, the terminal device sends a connection setup request message, for example, RRCSetupRequest, to the network device in a process of initiating random access, and receives a connection setup message, for example, an RRCSetup message, sent by the network device.

When the terminal device does not need to perform data transmission subsequently, the network device may release the terminal device, so that the terminal device enters the RRC_IDLE state or the RRC_INACTIVE state. For example, the network device sends a release message with a suspend indication, for example, RRCRelease with suspend indication, so that the terminal device enters the RRC_INACTIVE state. Alternatively, the network device sends a release message, for example, an RRCRelease message, so that the terminal device enters the RRC_IDLE state.

In addition, the terminal device in the RRC_INACTIVE state may further return to the RRC_CONNECTED state by using a resume message. For example, the terminal device sends an RRC resume request (RRCResumeRequest), receives an RRC resume (RRCResume) message, and returns to the RRC_CONNECTED state. Similarly, the network device may further release the terminal device, so that the terminal device enters the RRC_IDLE state.

For brief description, the RRC_IDLE state may also be briefly described as an idle state or an IDLE state; the RRC_INACTIVE state may also be briefly described as an inactive state or an INACTIVE state; and the RRC_CONNECTED state may also be briefly described as a connected state, an active state, or a CONNECTED state.

In conclusion, the several RRC states (which may also be referred to as states for short) of the terminal device have been described. Embodiments of this disclosure may be used by the terminal device in the RRC connected state, the RRC idle state, or the RRC inactive state to implement uplink data transmission, or may be used by a terminal device in a state other than the RRC connected state, the RRC idle state, and the RRC inactive state, for example, a terminal device that is not attached to a network or that does not perform downlink synchronization with the network, to implement uplink data transmission. This is not specifically required.

In this disclosure, the terminal device may send uplink data to the network device.

An uplink data transmission manner is uplink transmission based on a dynamic grant (DG) (or referred to as a dynamic uplink grant (dynamic UL grant)). In this manner, when the terminal needs to send user plane data to a base station, the terminal may monitor downlink control information (DCI) delivered by the base station through a physical downlink control channel (PDCCH). The DCI includes an uplink grant (UL grant). The uplink grant may be used to authorize the terminal to send the uplink data on a specified time-frequency resource by using a specified parameter, for example, a specified modulation and coding scheme (MCS). Before monitoring the DCI, the terminal may first send a scheduling request (SR) to the base station through a physical uplink control channel (PUCCH) or report a buffer state (BS) to the base station through a physical uplink shared channel (PUSCH), to notify the base station of an uplink sending requirement or the buffer state. This helps the base station perform the uplink grant and resource scheduling based on the requirement.

The terminal device may monitor the PDCCH based on a PDCCH configuration to obtain the DCI. The PDCCH configuration may include a control-resource set (CORESET) configuration, a search space configuration, a radio network temporary identifier (RNTI) configuration for scrambling/descrambling the PDCCH, a signaling format configuration, or another configuration for PDCCH detection.

A time-frequency resource used to transmit the DCI belongs to a configured control-

resource set (CORESET), and the terminal device may detect a candidate time-frequency resource location in the CORESET to receive the DCI.

It may be understood that the uplink data transmission manner provided in embodiments of this disclosure may further include data transmission in a random access (RA) process or grant-free (GF) data transmission. The data transmission in the RA process and the GF data transmission may be applied to a small data transmission (SDT) scenario. The following describes the two uplink data transmission manners with reference to small data transmission.

Currently, the 3rd generation partnership project (3GPP) supports the UE in the RRC idle state or the RRC inactive state in transmitting data, for example, small data. A corresponding transmission process may be referred to as the small data transmission. In the small data transmission scenario, a data amount of a data packet that the UE needs to transmit is usually very small, and a data amount of signaling needed for the UE to enter the RRC connected state from the RRC idle state or the RRC inactive state is even greater than the data amount in the small data transmission. If the UE in the RRC idle state or the RRC inactive state is required to enter the connected state before sending the small data, unnecessary power consumption and signaling overheads are caused. Therefore, the terminal is supported in directly transmitting the small data in the RRC idle state or the RRC inactive state, instead of transmitting the small data after entering the RRC connected state, so that signaling overheads and power consumption can be significantly reduced. For example, the small data transmission is an instant message of an instant messaging application (APP), heartbeat packets or push messages of various APPs, service data of a non-smartphone, for example, accuracy data (such as a heartbeat packet) of a wearable device, periodic read data sent by an industrial wireless sensor network, or data of a device such as a smart meter.

Currently, small data transmission of the UE in the RRC idle state or the RRC inactive state may be usually implemented by using the data transmission in the RA process and the GF data transmission. The two transmission manners respectively correspond to the following Manner 1 and Manner 2.

Manner 1: The small data transmission is implemented in RA, and a small data transmission process may be referred to as random access small data transmission (RA SDT). The RA small data transmission means that the terminal device sends the uplink data to the network device or receives downlink data in the RA process. For ease of description, all data in the following may be understood as the uplink data or the downlink data. In addition, the uplink data in this disclosure may also be replaced with the downlink data. For example, “sending the uplink data” and “receiving the downlink data” may be replaced with each other, and “sending the downlink data” and “receiving the uplink data” may be replaced with each other.

It may be understood that the RA may include 4-step RA and 2-step RA.

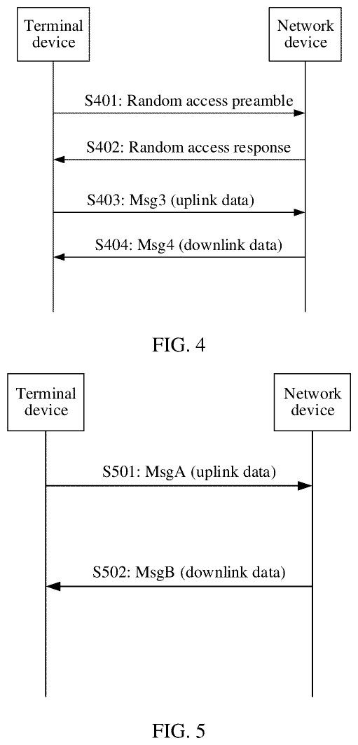

FIG. 4 shows an example of a small data transmission process in the 4-step RA.

S401: The terminal device sends a message 1 (Msg1) to the network device, and the network device receives the message 1 from the terminal device, where the message 1 is a random access preamble (which may be referred to as a preamble for short below), and the preamble is used by the network device to estimate a timing advance (TA) of the terminal device.

S402: The network device sends a message 2 (Msg2) to the terminal device, and the terminal device receives the message 2 from the network device.

The message 2 is a random access response.

S403: The terminal device sends a message 3 (Msg3) to the network device, and the network device receives the message 3 from the terminal device.

The Msg3 may carry the uplink data, for example, the small data.

S404: The network device sends a message 4 (Msg4) to the terminal device, and the terminal device receives the message 4 from the network device.

Optionally, the Msg4 carries the downlink data.

FIG. 5 shows an example of a small data transmission process in the 2-step RA.

S501: The terminal device sends a message A (MsgA) to the network device, and the network device receives the message A from the terminal device.

The MsgA may carry the uplink data, for example, the small data.

A transmission channel of the MsgA may include a physical random access channel (PRACH) and a physical uplink shared channel (PUSCH). The PRACH is used to send a preamble, used by the network device to estimate a timing advance of the terminal device, so that the terminal device implements uplink synchronization with the network device. The terminal device may further send the uplink data (for example, the small data) through the PUSCH of the MsgA. In other words, the PUSCH may be configured to carry the uplink data.

S502: The network device returns a message B (MsgB) to the terminal, and the terminal device receives the message B from the network device.

The downlink data may be carried in the MsgB. For example, the downlink data may be transmitted through a physical downlink shared channel (PDSCH) of the MsgB.

Manner 2: GF small data transmission. A GF small data transmission process is described as follows.

The network device pre-configures, for the terminal device in a semi-static manner, a PUSCH resource and a transmission parameter that are used for uplink data transmission. When needing to send the uplink data, the terminal device directly sends the data to the network device by using the pre-configured PUSCH resource and parameter, and does not need to receive a dynamic uplink grant from the network device or send a preamble to perform random access.

Both transmission based on a pre-configured uplink resource (PUR) in LTE and transmission based on a configured grant (CG) in NR belong to an uplink grant-free transmission category. The CG includes a first type (Type 1) CG and a second type (Type 2) CG. The transmission based on the PUR is similar to transmission based on the Type 1 CG. The network device configures a resource and a transmission parameter for the terminal device by using RRC signaling, for example, configures one or more of the following parameters: a periodicity of time domain resources, a parameter related to open-loop power control, a waveform, a redundancy version sequence, a quantity of repetition times, a frequency hopping mode, a resource allocation type, a quantity of hybrid automatic repeat request (HARQ) processes, a parameter related to a demodulation reference signal (DMRS), a modulation and coding scheme (MCS) table, a resource block group (RBG) size, a time domain resource, a frequency domain resource, an MCS, and the like.

In transmission based on the Type 2 CG, the network device uses a 2-step resource configuration manner. First, the network device delivers configured grant configuration information by using RRC signaling, where the configuration information is used to configure one or more of the following transmission resources and transmission parameters: a periodicity of a time domain resource, a parameter related to open-loop power control, a waveform, a redundancy version sequence, a quantity of repetition times, a frequency hopping mode, a resource allocation type, a quantity of HARQ processes, a parameter related to a demodulation reference signal, an MCS table, and an RBG size. Then, PUSCH transmission of the Type 2 CG is activated by using downlink control information (DCI) scrambled by using a configured scheduling radio network temporary identifier (CS-RNTI), and another transmission resource and another transmission parameter that include the time domain resource, the frequency domain resource, the DMRS, the MCS, and the like are configured.

A grant-free transmission technology may be applied to uplink transmission of the terminal in the RRC active state. For example, CG transmission (such as the Type 1 CG and the Type 2 CG) configured in 5G NR may be applied to the uplink transmission of the terminal in the RRC active state. In addition, the grant-free transmission technology may also be applied to uplink transmission of the terminal in the RRC idle state or the RRC inactive state. For example, the transmission based on the PUR may be applied to uplink transmission of the terminal in the idle state in LTE. For another example, the transmission based on the Type 1 CG may be applied to uplink transmission of the terminal in the RRC inactive state in 5G NR.

In grant-free small data transmission, the terminal device does not need to send the preamble. Therefore, the grant-free small data transmission is more applicable to a scenario in which the terminal device is synchronized with the network device. Compared with an RA-based solution, this solution can further reduce signaling overheads and power consumption of the terminal device.

In addition, a synchronization signal/physical broadcast channel block (SS/PBCH block) is further introduced in 5G NR. In this disclosure, the SS/PBCH block may also be referred to as a synchronization signal block (SSB). The SSB may include three parts: a primary synchronization signal (PSS), a secondary synchronization signal (SSS), and a master information block (MIB).

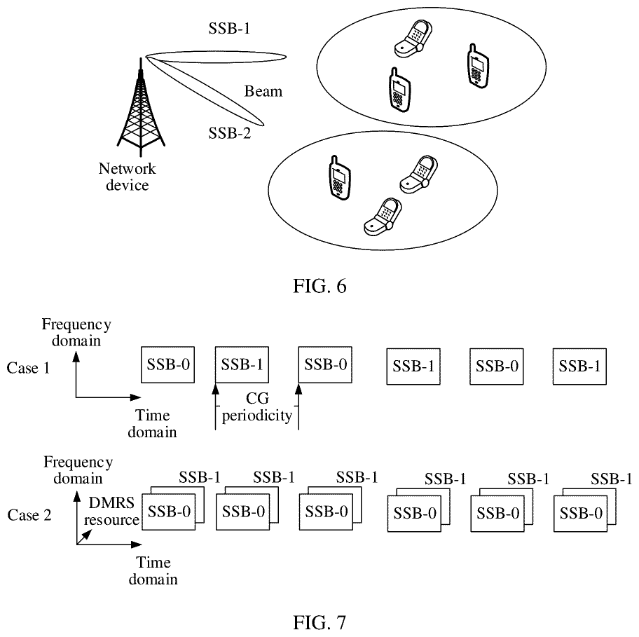

The network device sends a plurality of SSBs in a scanning manner in one periodicity, and different SSBs correspond to different spatial directions (for example, correspond to different beams). Therefore, a beam indication may also be implemented by using the SSB, or the SSB may be used as beam information. For example, as shown in FIG. 6, an SSB-1 and an SSB-2 respectively cover different areas, and the different areas may include different terminal devices. A quantity of SSBs may be configured by the network device for the terminal device by using a system message. Three quantities of SSBs: 4, 8, and 64 are supported in NR. Generally, a higher frequency indicates a larger quantity of SSBs and narrower beams for sending the SSBs.

The terminal device may measure a reference signal received power (RSRP) of an SSB sent by the network device. When an RSRP measurement result of an SSB is greater than or equal to a preset threshold, the terminal device may select a random access channel occasion (RACH occasion, RO) or a preamble to which the SSB is mapped, to perform an RA process, where one PRACH time-frequency resource may be referred to as one physical random access channel occasion. Therefore, there is a mapping relationship between an SSB and an RO or a preamble, and the mapping relationship may be one-to-many, one-to-one, or many-to-one. When performing 2-step RA or 4-step RA, the terminal may notify the base station of the selected SSB in an implicit manner by using the selected RO or preamble. In this way, when sending a response message (the MsgB or the Msg2), the base station may send the response message in a spatial direction that is the same as that of the SSB to which the RO or the preamble selected by the terminal is mapped. When receiving the response message, the terminal also assumes that a quasi co-location (QCL) feature is the same as that of the SSB to which the selected RO or preamble is mapped, so that the terminal can implicitly indicate the SSB to the network device. The QCL feature may also be referred to as a QCL relationship. The QCL relationship means that two reference signals have some same spatial parameters. The SSB is implicitly indicated through RA, so that the base station can preliminarily determine a location of the terminal, to perform more accurate beam management. The terminal measures an SSB sent by the base station. When a measurement result of an SSB exceeds a preset threshold, the terminal may select an RO or a preamble to which the SSB is mapped, to perform the RA process. Similar to RA, there may also be a mapping relationship between an SSB and a grant-free transmission resource in GF transmission. For example, there is a mapping relationship between an SSB and a time-frequency resource (transmission occasion, TO) or a DMRS. The relationship may also be one-to-many, one-to-one, or many-to-one.

Based on the foregoing descriptions of the small data transmission and the descriptions

of an SSB configuration manner, in current GF transmission, the base station configures, for the terminal by using a terminal-specific RRC message, a grant-free resource used for direct small data transmission in an inactive state, and the grant-free resource includes a periodic time-frequency resource, a DMRS resource, and a transmission parameter such as an MCS. When the terminal has an uplink data packet transmission requirement, the terminal sends data by using the configured time-frequency resource. When the time-frequency resource is shared by a plurality of terminals, the base station may distinguish between the terminals by using DMRS resources such as DMRS ports or DMRS sequences. For example, different terminals use different DMRS ports or sequences. In this disclosure, the time-frequency resource includes a time domain resource and a frequency domain resource. The DMRS resource may also be replaced with a code domain resource.

In addition, when configuring the time-frequency resource and the DMRS resource for the terminal, the base station associates the configured resource with a beam such as an SSB. In this way, the terminal side selects, based on a beam measurement result, a time-frequency resource or a DMRS resource associated with a beam to send data, to implement a beam indication, and the base station side receives, on the associated time-frequency resource by using a beam direction and by using the associated DMRS resource, the data sent by the terminal. For example, a method for associating the beam direction with the grant-free time-frequency resource and the DMRS resource is as follows: N (N≥1) SSBs are mapped to a plurality of combinations of time-frequency resources and DMRS resources in a sequence of the DMRS resource (port or sequence) and then the time-frequency resource. For example, when N=2, two different SSBs may be mapped to different time-frequency resources (as shown in a case 1 in FIG. 7) or different DMRS resources on a same time-frequency resource (as shown in a case 2 in FIG. 7).

To consider transmission of all terminals whose service types support GF transmission in a cell, the base station needs to configure a corresponding SSB for each terminal. However, because the terminals may be completely scattered in the cell, it means that the base station needs to configure associated time-frequency resources and DMRS resources for all or most beam directions (such as SSBs). As a result, time-frequency resources mapped to a same beam direction have a large time interval. Consequently, a quantity of terminal devices that perform multiplexing transmission within specific time is limited, and it is difficult to meet a terminal multiplexing transmission requirement brought by an increasing quantity of terminals. In addition, in a high-frequency scenario, a beam is narrower, and there are more beam directions. In addition, due to a limited quantity of receive and transmit channels, the base station can simultaneously serve a limited quantity of beam directions, and a quantity of terminal devices that can perform multiplexing transmission is further limited.

To improve an uplink data multiplexing transmission capability on a time-frequency resource, embodiments of this disclosure provide a data transmission method. The transmission method may be referred to as a data transmission method based on opportunistic multiple access (OpMA), and the method may alternatively be referred to as a data transmission method based on affiliated multiple access (AMA), or referred to as opportunity-based multiple access (OBMA) transmission. The method may be implemented by a network device and a terminal apparatus. For example, the network device may include the network device 101 shown in FIG. 1 or a component (such as a chip, a module, or a circuit) in the network device 101. The terminal apparatus may include the terminal device 102 shown in FIG. 1, or the terminal apparatus may include a component (such as a chip, a module, or a circuit) in the terminal device 102. The terminal apparatus may include a first terminal apparatus and a second terminal apparatus. The following describes the method by using an example in which the first terminal apparatus, the second terminal apparatus, and the network device are execution bodies. The first terminal apparatus may be a first terminal device or a component in the first terminal device, and the second terminal apparatus may be a second terminal device or a component in the second terminal device. Optionally, the first terminal device and the second terminal device are different terminal devices. For example, optionally, the first terminal device and the second terminal device are different terminals in a coverage area of a same beam. In this disclosure, the second terminal device may be used as a primary terminal, in other words, a time-frequency resource corresponding to first uplink grant information is originally allocated by the network device to the second terminal device.

The first terminal device may be used as a secondary terminal in this disclosure. In some conditions, the secondary terminal in this disclosure may perform uplink data transmission by using the time-frequency resource allocated by the network device to the primary terminal. Alternatively, both the first terminal device and the second terminal device are used as secondary terminals, or the second terminal device is one or more secondary terminals including the first terminal device. In this case, there may be no primary terminal, in other words, there is no need to distinguish between the primary terminal and the secondary terminal. The following describes a procedure of the method with reference to FIG. 8.

As shown in FIG. 8, the data transmission method provided in embodiments of this disclosure may include steps shown in S801 to S803. The following separately describes the steps.

S801: The first terminal apparatus obtains the first uplink grant information.

The time-frequency resource corresponding to the first uplink grant information is used for uplink transmission of the second terminal apparatus. In other words, the first uplink grant information may be used by the second terminal apparatus to send uplink data on the corresponding time-frequency resource by using a specified parameter (for example, an MCS) and the like. In other words, the time-frequency resource corresponding to the first uplink grant information may be a time-frequency resource allocated by the network device to the primary terminal (for example, the second terminal apparatus). When having an uplink data transmission requirement, the secondary terminal (for example, the first terminal apparatus) performs data transmission by using a time-frequency resource allocated by a base station to the primary terminal (for example, the second terminal apparatus), to be specific, performs uplink opportunistic transmission, affiliated transmission, or opportunity-based multiple access uplink transmission. Alternatively, both the first terminal apparatus and the second terminal apparatus are used as secondary terminals. Therefore, the time-frequency resource corresponding to the first uplink grant information may be a resource allocated by the network device to a group (or at least one) of secondary terminals.

In this disclosure, the time-frequency resource corresponding to the first uplink grant information may be a time-frequency resource indicated by the first uplink grant information. The time-frequency resource may be further used by the first terminal apparatus to send the uplink data.

The following describes a manner in which the first terminal apparatus determines the time-frequency resource.

In an example, the first uplink grant information may include time-frequency resource information of the time-frequency resource. In other words, the time-frequency resource corresponding to the first uplink grant information is indicated by the time-frequency resource information included in the first uplink grant information. For example, the first uplink grant information includes time domain location information and frequency domain location information of the time-frequency resource.

In another example, the network device may configure a transmission resource set for the terminal by using an RRC message, a MAC CE, or DCI. The first uplink grant information may carry indication information indicating a transmission resource from the transmission resource set. The transmission resource may include a time-frequency resource (to be specific, a time domain resource and a frequency domain resource). In addition, the transmission resource may further include a space domain resource, a code domain resource (such as a DMRS), a multiple access signature, or the like. The time-frequency resource determined based on the indication information in the first uplink grant information is the time-frequency resource corresponding to the first uplink grant information. For example, the first uplink grant information may include an index of a time-frequency resource in the resource set.

In another example, the time-frequency resource indicated by the first uplink grant information may be a time-frequency resource corresponding to at least one of an RNTI, a CORESET, search space, or a signaling format used to receive the first uplink grant information. In other words, the time-frequency resource indicated by the first uplink grant information is implicitly indicated by using the at least one of the RNTI, the CORESET, the search space, or the signaling format used to receive the first uplink grant information. For example, the at least one of the RNTI, the CORESET, the search space, or the signaling format used to receive the first uplink grant information corresponds to a transmission resource. Optionally, the first terminal apparatus may receive a first correspondence from the network device, where the first correspondence may include a correspondence between the transmission resource and the at least one of the RNTI, the CORESET, the search space, or the signaling format used to receive the first uplink grant information. Alternatively, the first correspondence may be stored in the first terminal apparatus. For example, the correspondence may be pre-configured by the network device by using signaling, or may be defined in a protocol, or may be pre-configured in the first terminal apparatus. When receiving the first uplink grant information based on the at least one of the RNTI, the CORESET, the search space, or the signaling format, the first terminal apparatus may further determine the time-frequency resource corresponding to the first uplink grant information based on the first correspondence and the at least one of the RNTI, the CORESET, the search space, or the signaling format of the first uplink grant information.

It may be understood that, for the network device that sends the first uplink grant information, the foregoing RNTI, CORESET, search space, or signaling format used to receive the first uplink grant information may be referred to as an RNTI, a CORESET, search space, or a signaling format used to send the first uplink grant information.

Optionally, the at least one of the RNTI, the CORESET, the search space, or the signaling format used to receive the first uplink grant information may be allocated to one or more terminals (including the first terminal apparatus and/or the second terminal apparatus) .

For example, the first correspondence includes a correspondence between an RNTI-1 and a time-frequency resource 1. When the first terminal apparatus receives the first uplink grant information based on the RNTI-1, the time-frequency resource corresponding to the first uplink grant information is the time-frequency resource 1.

It should be understood that the time-frequency resource corresponding to the first uplink grant information may be a time-frequency resource allocated by the network device to the second terminal apparatus. Therefore, the second terminal apparatus may perform uplink transmission by using the time-frequency resource.

In a first implementation of S801, the first uplink grant information is dynamic grant information sent by the network device. For example, according to descriptions in this disclosure, the second terminal apparatus may send a scheduling request to the network device through a PUCCH, or the second terminal apparatus may send a buffer state to the network device through the PUSCH, and then the network device may send the first uplink grant information, to schedule uplink data transmission of the second terminal apparatus. Optionally, the first uplink grant information may include the time-frequency resource used by the second terminal apparatus to perform uplink data transmission. Optionally, the first uplink grant information may be sent by the network device in a unicast, groupcast, or broadcast manner.

For example, the first uplink grant information may be a physical layer signal. For example, the first uplink grant information is DCI, and the first uplink grant information may be sent through a PDCCH. For another example, the first uplink grant information may alternatively be a MAC layer signal, for example, a MAC control element (CE). In this case, the first grant information may be delivered through, for example, a PDSCH. A difference between the DCI and the MAC control element lies in that the DCI is usually scrambled by using a specific RNTI before being sent. Therefore, the terminal can correctly receive the DCI sent by the base station to the terminal only after determining the RNTI. However, the MAC CE does not need to be scrambled by using a specific RNTI before being received.

If the first uplink grant information is the DCI, the RNTI used by the first terminal apparatus to receive the first uplink grant information may be pre-configured by the network device by using signaling. For example, the network device may configure the RNTI for the first terminal apparatus by using an RRC message, a MAC CE, or DCI.

Alternatively, the RNTI may be calculated by the first terminal apparatus based on a resource such as the time domain resource, the frequency domain resource, the code domain resource, or the multiple access signature. For example, the network device configures, for the first terminal apparatus, a transmission resource including the time domain resource, the frequency domain resource, the code domain resource, the multiple access signature, or the like, where the transmission resource is, for example, a grant-free transmission resource. The terminal may calculate the RNTI based on the resources, and receive, based on the RNTI, the first uplink grant information sent through the PDCCH. For example, a corresponding RNTI is set for the grant-free resource, or a corresponding parameter used to calculate the RNTI is set for the grant-free resource, and is used by the first terminal apparatus to calculate the RNTI.

It should be understood that, the first uplink grant information herein may be sent by the network device to the second terminal apparatus, and the network device may configure a transmission resource including any one or more of the time domain resource, the frequency domain resource, the code domain resource, the multiple access signature, or the like for at least one terminal apparatus (including the first terminal apparatus) in advance, where the transmission resource is, for example, a grant-free transmission resource. When sending dynamic grant information (for example, the time-frequency resource indicating the second terminal apparatus to perform uplink transmission) to the second terminal apparatus, the network device calculates an

RNTI of the dynamic grant information based on the configured transmission resource, and sends the dynamic grant information based on the RNTI. If the first terminal apparatus has an uplink transmission requirement, the first terminal apparatus may also calculate the RNTI based on the configured transmission resource. If the first terminal apparatus successfully receives the dynamic grant information based on the RNTI, the dynamic grant information may be used as the first uplink grant information. If the first terminal apparatus does not successfully receive the dynamic grant information based on the RNTI, it indicates that there is no uplink grant information corresponding to the time-frequency resource.

The code domain resource herein may be a DMRS resource such as a DMRS port, a preamble resource, or a sequence resource. The sequence resource includes, for example, a ZC (Zadoff-Chu) sequence, a covered-ZC sequence, a pseudo-noise (PN) sequence, a longest linear feedback shift register (M) sequence, a Golden sequence, a Reed-Muller sequence, a discrete Fourier transform (DFT) sequence, an inverse discrete Fourier transform (IDFT) sequence, or a Hadamard sequence.

The multiple access signature herein includes but is not limited to a codebook, a pattern, a sequence, and the like that can be used for, that can assist, or that can enhance multi-user detection or multi-data reception, for example, a spreading sequence, a spreading pattern, a resource mapping pattern, or a resource hopping pattern.

In the first implementation, the first uplink grant information may include explicit indication information of a transmission resource and/or a transmission parameter, or the first uplink grant information may include the transmission resource and/or the transmission parameter. The transmission resource and/or the transmission parameter may be used by the first terminal apparatus to send the uplink data. In this disclosure, the transmission resource includes but is not limited to any one or more resources such as the time domain resource, the frequency domain resource, the code domain resource, or the multiple access signature resource. The transmission parameter in this disclosure includes but is not limited to a parameter such as an MCS, a power control parameter, or a quantity of repeated transmission times. The first terminal apparatus may send the uplink data to the network device based on the transmission resource and/or the transmission parameter.

Specifically, the first uplink grant information may specifically include resource

information of the transmission resource and/or the transmission parameter. Therefore, the first uplink grant information may directly indicate the transmission resource and/or the transmission parameter. Alternatively, the first uplink grant information may indicate a transmission resource from a transmission resource set, where the transmission resource set may be indicated by the network device by using an RRC message, a MAC CE, or DCI; and/or the first uplink grant information may indicate a transmission parameter from a transmission parameter set, where the transmission parameter set may be indicated by the network device by using an RRC message, a MAC CE, or DCI.

In addition, the first uplink grant information may implicitly indicate the transmission resource and/or the transmission parameter. For example, as described above, the at least one of the RNTI, the CORESET, the search space, or the signaling format used to receive the first uplink grant information may correspond to the transmission resource. Therefore, after the first terminal apparatus receives the first uplink grant information, the transmission resource corresponding to the at least one of the RNTI, the CORESET, the search space, or the signaling format may be used as the transmission resource used to send the uplink data.

Similarly, the at least one of the RNTI, the CORESET, the search space, or the signaling format used to receive the first uplink grant information may correspond to the transmission parameter, and the transmission parameter corresponding to the at least one of the RNTI, the CORESET, the search space, or the signaling format may be used as the transmission parameter used to send the uplink data.

Optionally, the first terminal apparatus may receive a second correspondence from the network device, where the second correspondence may include a correspondence between the transmission parameter and the at least one of the RNTI, the CORESET, the search space, or the signaling format used to receive the first uplink grant information. Alternatively, the second correspondence may be stored in the first terminal apparatus. For example, the correspondence may be pre-configured by the network device by using signaling, or may be defined in a protocol, or may be pre-configured in the first terminal apparatus. When receiving the first uplink grant information based on the at least one of the RNTI, the CORESET, the search space, or the signaling format, the first terminal apparatus may further determine the transmission parameter based on the second correspondence and the at least one of the RNTI, the CORESET, the search space, or the signaling format of the first uplink grant information.

In addition, in some embodiments, in the first implementation of S801, the first uplink grant information may be used by the first terminal apparatus to determine a beam direction corresponding to the first uplink grant information, where the first uplink grant information may include indication information of the beam direction, or the first uplink grant information may implicitly indicate the beam direction. The beam direction may be used by the first terminal apparatus to determine whether to send the uplink data on the time-frequency resource corresponding to the first uplink grant information. For details, refer to descriptions in S803. Details are not described herein. A beam herein may be a beam used by the network device for reception.

In an example, the first uplink grant information may include beam indication information (which may also be referred to as indication information of the beam direction), used to explicitly indicate the beam direction. For example, the beam indication information may include indication information of a reference signal associated with the beam direction or a beam direction identifier. The indication information of the reference signal associated with the beam direction includes, for example, an index of the reference signal representing the beam direction, for example, an SSB index or a CSI-RS index. The beam direction identifier may be, for example, an index or an identifier corresponding to the beam direction.

In another example, the first terminal apparatus may determine the beam direction based on the at least one of the RNTI, the CORESET, the search space, or the signaling format used to receive the first uplink grant information. For example, the at least one of the RNTI, the CORESET, the search space, or the signaling format used to receive the first uplink grant information may correspond to the beam direction. Therefore, after the first terminal apparatus receives the first uplink grant information, the beam direction corresponding to the at least one of the RNTI, the CORESET, the search space, or the signaling format may be used as the beam direction herein. In other words, the first uplink grant information may implicitly indicate the beam direction. Optionally, the first terminal apparatus may receive a third correspondence from the network device, where the third correspondence may include a correspondence between the beam direction and the at least one of the RNTI, the CORESET, the search space, or the signaling format used to receive the first uplink grant information. Alternatively, the third correspondence may be stored in the first terminal apparatus. For example, the correspondence may be pre-configured by the network device by using signaling, or may be defined in a protocol, or may be pre-configured in the first terminal apparatus. When receiving the first uplink grant information based on the at least one of the RNTI, the CORESET, the search space, or the signaling format, the first terminal apparatus may further determine the beam direction corresponding to the first uplink grant information based on the third correspondence and the at least one of the RNTI, the CORESET, the search space, or the signaling format of the first uplink grant information.

For example, the third correspondence includes a correspondence between an RNTI-1 and an SSB-1 (or an index of the SSB-1), and includes a correspondence between an RNTI-2 and an SSB-2 (or an index of the SSB-2). When the first terminal apparatus receives the first uplink grant information based on the RNTI-1, the first terminal apparatus may use a beam direction associated with the SSB-1 as the beam direction, or use the SSB-1 as the beam direction. When the first terminal apparatus receives the first uplink grant information based on the RNTI-2, the first terminal apparatus may use a beam direction associated with the SSB-2 as the beam direction, or use the SSB-2 as the beam direction.

In a second implementation of S801, the first uplink grant information may be from the second terminal apparatus. For example, the second terminal apparatus may send the first uplink grant information to the first terminal apparatus based on second uplink grant information from the network device.

The second terminal apparatus may send the first uplink grant information to the first

terminal apparatus in a unicast, groupcast (groupcast), multicast, or broadcast manner through any communication link between terminals, for example, a D2D link, a sidelink, or Bluetooth. For example, the first uplink grant information may be carried on a physical sidelink control channel (PSCCH) or a physical sidelink shared channel (PSSCH).

In the second implementation, according to descriptions in this disclosure, optionally, the second terminal apparatus may send a scheduling request to the network device through a PUCCH, or the second terminal apparatus may send a buffer state to the network device through a PUSCH, and the second terminal apparatus may receive the second uplink grant information from the network device. The second terminal apparatus may determine the first uplink grant information based on the received second uplink grant information, and send the first uplink grant information to the first terminal apparatus. For example, the second terminal apparatus may determine a time-frequency resource based on the second uplink grant information, and include indication information of the time-frequency resource in the first uplink grant information.

The second terminal apparatus may determine, based on an explicit indication carried in the second uplink grant information, that the second uplink grant information is used by the second terminal apparatus to perform uplink data transmission. In other words, the second terminal apparatus may determine, based on the explicit indication carried in the second uplink grant information, that the second terminal apparatus is the primary terminal. In addition, in the second implementation, it is not excluded that the second terminal apparatus is the secondary terminal. For example, the first terminal apparatus and the second terminal apparatus are used as a group of secondary terminals, and the second terminal apparatus may be configured to forward the received uplink grant information to another secondary terminal (for example, including the first terminal apparatus).

In addition, in the second implementation, the first uplink grant information may further include a transmission resource (or indication information of the transmission resource) and/or a transmission parameter (or indication information of the transmission parameter) that are/is used by the first terminal apparatus to perform uplink transmission with the network device. Optionally, the second uplink grant information may include a transmission resource and/or a transmission parameter that are/is used by the second terminal apparatus to perform uplink transmission, and the transmission resource and/or the transmission parameter that are/is used by the first terminal apparatus to perform uplink transmission with the network device and that are/is in the first uplink grant information may be the same as the transmission resource and/or the transmission parameter that are/is used by the second terminal apparatus to perform uplink transmission and that are/is included in the second uplink grant information.

In some embodiments, the first uplink grant information may include indication information of a transmission resource and/or a transmission parameter that are/is used and/or cannot be used by the first terminal apparatus to transmit the uplink data to the network device.

In the second implementation, the first uplink grant information may further include beam indication information. For example, the beam indication information may include indication information of a reference signal associated with a beam direction or a beam direction identifier. For details, refer to the descriptions of the beam indication information in the first implementation of S801 in this disclosure. The beam direction may be indicated by the second uplink grant information, and the second uplink grant information may explicitly or implicitly indicate the beam direction. For an explicit indication manner and an implicit indication manner, refer to manners of explicitly and implicitly indicating the beam direction in the first implementation of S801. Details are not described again.

It should be understood that in the implementations of S801, in addition to the transmission resource and the transmission parameter, the first uplink grant information may further include other information used by the first terminal apparatus to perform uplink transmission. For example, the information includes an identifier of the primary terminal, an identifier of the secondary terminal, or indication information indicating whether the first terminal apparatus (or the secondary terminal) is allowed to perform uplink transmission by using the first uplink grant information (or the time-frequency resource).

The identifier of the secondary terminal may explicitly indicate the secondary terminal. An identifier of the first terminal apparatus and/or the identifier of the secondary terminal are/is, for example, a UE ID, or may include other information that can be used to identify a terminal type, for example, information such as a time-frequency resource or a DMRS resource or sequence corresponding to the terminal when the terminal can be identified by using the time-frequency resource or the DMRS resource or sequence. The terminal type in this disclosure indicates that the terminal is the primary terminal or the secondary terminal. Similarly, the identifier of the primary terminal may explicitly indicate the primary terminal (for example, the second terminal apparatus). The identifier of the primary terminal may be a UE ID of the terminal, or may include other information that can be used to identify the terminal. In addition, the identifier of the secondary terminal and the identifier of the primary terminal may also be used as an identifier of a terminal allowed to send data. If an identifier of a terminal receiving the first uplink grant information is not included in the identifier of the terminal allowed to send the data, it indicates that the terminal is not allowed to send the uplink data by using the first uplink grant information.

Optionally, after receiving the first uplink grant information, the first terminal apparatus may determine, based on the first uplink grant information, that the first terminal apparatus is used as the secondary terminal. In addition, after receiving the first uplink grant information or the second uplink grant information, the second terminal apparatus may determine, based on the first uplink grant information or the second uplink grant information, that the second terminal apparatus is used as the primary terminal.

In this disclosure, when a terminal receives uplink grant information (including the first uplink grant information and/or the second uplink grant information), and the uplink grant information indicates only the primary terminal (for example, carries the identifier of the primary terminal), if the terminal determines that the terminal is not the primary terminal, for example, the identifier of the primary terminal does not include an identifier of the terminal, in some embodiments, the terminal determines that the terminal is the secondary terminal; or if the terminal determines that the identifier of the primary terminal includes an identifier of the terminal, the terminal determines that the terminal is the primary terminal. Similarly, when a terminal receives uplink grant information (including the first uplink grant information and/or the second uplink grant information), and the uplink grant information indicates only the secondary terminal (for example, carries the identifier of the secondary terminal), if the terminal determines that the terminal is not the secondary terminal, for example, the identifier of the secondary terminal does not include an identifier of the terminal, in some embodiments, the terminal determines that the terminal is the primary terminal; or if the terminal determines that the identifier of the secondary terminal includes an identifier of the terminal, the terminal determines that the terminal is the secondary terminal.

In addition, it should be understood that at least one of an RNTI, a CORESET, search space, or a signaling format used to receive the uplink grant information (including the first uplink grant information and/or the second uplink grant information) may correspond to the primary terminal or the secondary terminal, so that the terminal type can be implicitly indicated by using the uplink grant information. In an optional example, there is a correspondence (which may be referred to as a fourth correspondence) between the terminal type (for example, including the primary terminal and the secondary terminal) and the at least one of the RNTI, the CORESET, the search space, or the signaling format used to receive the first uplink grant information. For example, the network device configures two RNTIs: an RNTI-1 and an RNTI-2 for a terminal, and the two RNTIs are respectively associated with two types: the primary terminal and the secondary terminal. When the terminal receives a dynamic grant instruction by using the RNTI-1, the terminal determines that the terminal is the primary terminal. When the terminal receives a dynamic grant instruction by using the RNTI-2, the terminal determines that the terminal is the secondary terminal.

The indication information indicating whether the first terminal apparatus (or the secondary terminal) is allowed to perform uplink transmission by using the first uplink grant information (or the time-frequency resource) may include specific bit information in the first uplink grant information. For example, when a value of a specific bit in the first uplink grant information is “0”, it indicates indication information indicating that the first terminal apparatus (or the secondary terminal) is allowed to perform uplink transmission by using the first uplink grant information (or the time-frequency resource). When a value of a specific bit is “1”, it indicates indication information indicating that the first terminal apparatus (or the secondary terminal) is not allowed to perform uplink transmission by using the first uplink grant information (or the time-frequency resource). For another example, when a value of a specific bit in the first uplink grant information is “1”, it indicates indication information indicating that the first terminal apparatus (or the secondary terminal) is allowed to perform uplink transmission by using the first uplink grant information (or the time-frequency resource). When a value of a specific bit is “0”, it indicates indication information indicating that the first terminal apparatus (or the secondary terminal) is not allowed to perform uplink transmission by using the first uplink grant information (or the time-frequency resource). It may be understood that, in this disclosure, there is no specific requirement on a name of the indication information indicating that the first terminal apparatus (or the secondary terminal) is allowed to perform uplink transmission by using the first uplink grant information (or the time-frequency resource). The indication information may alternatively have another name, for example, indication information indicating whether the secondary terminal is allowed to perform transmission, or information indicating whether only the primary terminal performs transmission.

Optionally, when the first uplink grant information includes the identifier of the first terminal apparatus, or includes the indication information indicating that the first terminal apparatus is allowed to perform uplink transmission by using the first uplink grant information (or the time-frequency resource), the first terminal apparatus may perform uplink data transmission based on the first uplink grant information. Otherwise, if the first uplink grant information does not include the identifier of the first terminal apparatus, or does not include the indication information indicating that the first terminal apparatus is allowed to perform uplink transmission by using the time-frequency resource, the first terminal apparatus does not perform uplink transmission based on the first uplink grant information (or the time-frequency resource). In other words, the first terminal apparatus ignores performing uplink transmission based on the first uplink grant information (or the time-frequency resource).

S802: The first terminal apparatus determines the beam direction based on the first uplink grant information.

For example, according to the descriptions in S801, the first uplink grant information may include the beam indication information indicating the beam direction. For example, the beam indication information includes the indication information of the reference signal associated with the beam direction or the beam direction identifier. Correspondingly, in S802, the first terminal apparatus may determine the beam direction based on the beam indication information.

For another example, the at least one of the RNTI, the CORESET, the search space, or the signaling format used to receive the first uplink grant information may correspond to the beam direction. Correspondingly, in S802, the first terminal apparatus may determine the beam direction based on the at least one of the RNTI, the CORESET, the search space, or the signaling format used to receive the first uplink grant information. For example, after receiving the first uplink grant information based on an RNTI #1, the first terminal apparatus may determine the beam direction corresponding to the first uplink grant information based on the RNTI and the third correspondence.

As described in S801, the third correspondence may indicate the correspondence between the beam direction (or the indication information of the reference signal associated with the beam direction) and the at least one of the RNTI, the CORESET, the search space, or the signaling format. For example, when the third correspondence indicates that the RNTI #1 corresponds to an SSB #1, the first terminal apparatus may determine that the beam direction is a beam direction associated with the SSB #1.

S803: When the beam direction meets a preset condition, the first terminal apparatus sends the uplink data on the time-frequency resource corresponding to the first uplink grant information.

In addition, when the beam direction does not meet the preset condition, the first terminal apparatus skips sending (or ignores sending) the uplink data on the time-frequency resource corresponding to the first uplink grant information. Alternatively, when the beam direction does not meet the preset condition, the first terminal apparatus sends the uplink data on a time-frequency resource other than the time-frequency resource corresponding to the first uplink grant information, to avoid a transmission failure and interference caused to transmission of the second terminal apparatus.

The preset condition may be indicated by the network device by using an RRC message, a MAC CE, or DCI, or the preset condition may be predefined in a protocol or pre-configured in the first terminal apparatus.

For example, the preset condition includes at least one of a condition 1 and a condition 2. The condition 1 is that a signal measurement value corresponding to the beam direction meets a threshold condition. The condition 2 is that a beam direction of the first terminal apparatus includes the beam direction.

The following separately describes the condition 1 and the condition 2.

In the condition 1, the first terminal apparatus may determine, based on a measurement

result of the beam direction, whether the beam direction needs to meet the preset condition. For example, when the reference signal can represent the beam direction, the first terminal apparatus determines, based on a measurement value of signal quality of the reference signal corresponding to the beam direction and a threshold condition (or a signal quality threshold), whether the beam direction meets the preset condition. The signal quality herein includes but is not limited to measurement of a reference signal received power (RSRP), reference signal received quality (RSRQ), a signal to interference plus noise ratio (SINR), a received signal strength indicator (RSSI), a path loss (PL), an angle of arrival (AoA) of the signal, and a time difference of arrival (TDOA). For example, when the RSRP of the reference signal exceeds a preset RSRP threshold, the first terminal apparatus determines that the beam direction meets the preset condition.

In the condition 2, when the network device configures a transmission resource such as a grant-free transmission resource for the first terminal apparatus, the preset condition may include whether the beam direction is (or is included in) a beam direction configured by the network device for grant-free transmission of the first terminal apparatus. If the beam direction is the beam direction configured by the network device for the grant-free transmission of the first terminal apparatus, or the beam direction is included in the beam direction configured by the network device for the grant-free transmission of the first terminal apparatus, the first terminal apparatus may determine that the beam direction meets the preset condition.

It should be understood that the condition 1 and the condition 2 are exemplary conditions. During actual use, one of the condition 1 and the condition 2 may be used as the preset condition. To be specific, when determining that one of the condition 1 and the condition 2 is met, the first terminal apparatus determines that the preset condition is met. Alternatively, a combination of the condition 1 and the condition 2 may be used as the preset condition. To be specific, when determining that the condition 1 and the condition 2 are met, the first terminal apparatus determines that the preset condition is met.

It should be further understood that in S803, the first terminal apparatus may send the uplink data to the network device based on the transmission resource and/or the transmission parameter. Optionally, the transmission resource and/or the transmission parameter may be determined by the first terminal apparatus based on the first uplink grant information. For details, refer to the descriptions in S801. For example, the first uplink grant information may specifically include information of the transmission resource and/or the transmission parameter. For another example, the first uplink grant information may alternatively indicate a transmission resource from a transmission resource set, and/or the first uplink grant information may indicate a transmission parameter from a transmission parameter set. For still another example, the first uplink grant information may implicitly indicate the transmission resource and/or the transmission parameter. Optionally, the transmission resource and/or the transmission parameter may be pre-configured by the network device for the first terminal apparatus by using signaling such as RRC, DCI, or a MAC CE.

A manner of configuring at least one of the first correspondence, the second correspondence, the third correspondence, and the fourth correspondence in this disclosure is described herein by using examples.

In some embodiments, the network device may send or indicate, to the terminal device, a correspondence between the at least one of the RNTI, the CORESET, the search space, or the signaling format and at least one of the transmission resource, the transmission parameter, the beam direction, and the terminal type. When the correspondence includes a correspondence between the transmission resource and the at least one of the RNTI, the CORESET, the search space, or the signaling format, the correspondence includes the first correspondence. When the correspondence includes a correspondence between the transmission parameter and the at least one of the RNTI, the CORESET, the search space, or the signaling format, the correspondence includes the second correspondence. When the correspondence includes a correspondence between the beam direction and the at least one of the RNTI, the CORESET, the search space, or the signaling format, the correspondence includes the third correspondence. When the correspondence includes a correspondence between the terminal type and the at least one of the RNTI, the CORESET, the search space, or the signaling format, the correspondence includes the fourth correspondence.

For example, when the correspondence includes the correspondence between the transmission resource and/or the transmission parameter and the at least one of the RNTI, the CORESET, the search space, or the signaling format, the first terminal apparatus may determine the transmission resource based on the correspondence and the at least one of the RNTI, the CORESET, the search space, or the signaling format used to receive the first uplink grant information, and send the uplink data by using the transmission resource and/or the transmission parameter. Correspondingly, the network device may receive the uplink data from the first terminal apparatus based on the transmission resource and/or the transmission parameter.

For another example, when the correspondence includes the correspondence between the beam direction and the at least one of the RNTI, the CORESET, the search space, or the signaling format, the first terminal apparatus may determine the beam direction based on the correspondence and the at least one of the RNTI, the CORESET, the search space, or the signaling format used to receive the first uplink grant information, and determine, based on the beam direction, whether to send the uplink data on the time-frequency resource corresponding to the first uplink grant information. For details, refer to the descriptions in S803.

For another example, when the correspondence includes the correspondence between the terminal type and the at least one of the RNTI, the CORESET, the search space, or the signaling format, the first terminal device may determine the terminal type based on the correspondence and the at least one of the RNTI, the CORESET, the search space, or the signaling format used to receive the first uplink grant information, where the terminal type is the secondary terminal or the primary terminal. If the terminal type is the secondary terminal, the first terminal apparatus may perform a procedure shown in FIG. 8, to implement opportunistic transmission or affiliated transmission.

In another example, a correspondence between the at least one of the RNTI, the CORESET, the search space, or the signaling format and at least one of the transmission resource, the transmission parameter, the beam direction, and the terminal type may be stored in the first terminal apparatus. For example, the correspondence may be pre-configured by the network device by using signaling, or may be defined in a protocol, or may be pre-configured in the first terminal apparatus. For a manner of using the correspondence, refer to the foregoing examples. Details are not described again.

In some embodiments, when receiving the first uplink grant information, the first terminal apparatus may directly send the uplink data by using the time-frequency resource corresponding to the first uplink grant information, and does not need to perform an action of determining the beam direction in S802 or an action of determining whether the beam direction meets the preset condition in S803. For example, the base station configures the first terminal apparatus to receive the first uplink grant information only when the first terminal apparatus and the second terminal apparatus have a same beam direction. In this case, when the first terminal apparatus can receive the first uplink grant information, the first terminal apparatus may send the uplink data by using the corresponding time-frequency resource by default.

In addition, a correspondence between at least two of information such as the beam

direction, the transmission resource, the transmission parameter, or the terminal type may be set by the network device or in a pre-configured or predefined manner, to implicitly indicate the information. For example, a correspondence between the beam direction and the transmission resource and/or the transmission parameter may be set, so that after determining the beam direction in any manner shown in this disclosure, the first terminal apparatus may determine the transmission resource and/or the transmission parameter based on the correspondence between the beam direction and the transmission resource and/or the transmission parameter. Similarly, after determining the transmission resource and/or the transmission parameter in any manner shown in this disclosure, the first terminal apparatus may also determine the beam direction based on the correspondence.

Optionally, before step S801, if supporting uplink data transmission based on uplink opportunistic multiple access or affiliated multiple access (which is referred to as opportunistic transmission or affiliated transmission for short below) or having an opportunistic transmission or affiliated transmission capability, the first terminal apparatus may report a request or capability information to the network device, to indicate that the first terminal apparatus supports the opportunistic transmission or the affiliated transmission. Further, optionally, the network device may configure an opportunistic transmission mode or an affiliated transmission mode for the first terminal apparatus (for example, a terminal apparatus that supports the opportunistic transmission or the affiliated transmission, or a plurality of unspecified terminal apparatuses in a broadcast manner), or configure one or more of the following information: a parameter used to receive the first grant information sent by the network device, for example, the RNTI, the CORESET, the SS, or the signaling format, a parameter used to receive the first grant information sent by the second terminal device, for example, a PSCCH and/or PSSCH channel configuration, and the transmission resource and/or the transmission parameter used to send data.

In addition, optionally, before step S801, if the second terminal apparatus can be used as the primary terminal or has a capability of the primary terminal, the second terminal apparatus may report capability information to the network device. Further, optionally, the network device may configure a primary terminal mode for the second terminal apparatus (for example, a terminal apparatus that can be used as the primary terminal, or a plurality of unspecified terminal apparatuses in a broadcast manner), or configure one or more of the following information: a parameter used to receive the first grant information and/or the second grant information sent by the network device, for example, the RNTI, the CORESET, the SS, or the signaling format, and a parameter used to send the first grant information to the second terminal device, for example, a PSCCH and/or PSSCH channel configuration.

It may be understood that, in any embodiment of this disclosure, the network device

may send configuration information to the first terminal apparatus and/or the second terminal apparatus by using one or more types of signaling in an RRC message, a MAC CE, or DCI, to configure an uplink transmission mode based on opportunistic transmission or multiple access and/or a related parameter. The related parameter includes but is not limited to the beam direction, the transmission resource used to send data, the transmission parameter, and a parameter used to receive an uplink grant information, for example, the RNTI, the CORESET, the search space, or the signaling format.

It may be further understood that, in any embodiment of this disclosure, optionally, the network device may pre-configure the primary terminal (including the second terminal apparatus) and the secondary terminal (including the first terminal apparatus), and configure a communication link between the primary terminal and the secondary terminal. For example, the network device pre-configures a group of terminals (for example, including the first terminal apparatus and the second terminal apparatus) that are at close locations or have similar beam directions and that may communicate with each other. One or more terminals in the group of terminals may be used as primary terminals to perform steps of the primary terminal in embodiments of the present invention, and one or more terminals in the group of terminals may be used as secondary terminals to perform steps of the secondary terminal in embodiments of the present invention. Optionally, in the group of terminals, one terminal may be the primary terminal, or may be the secondary terminal.

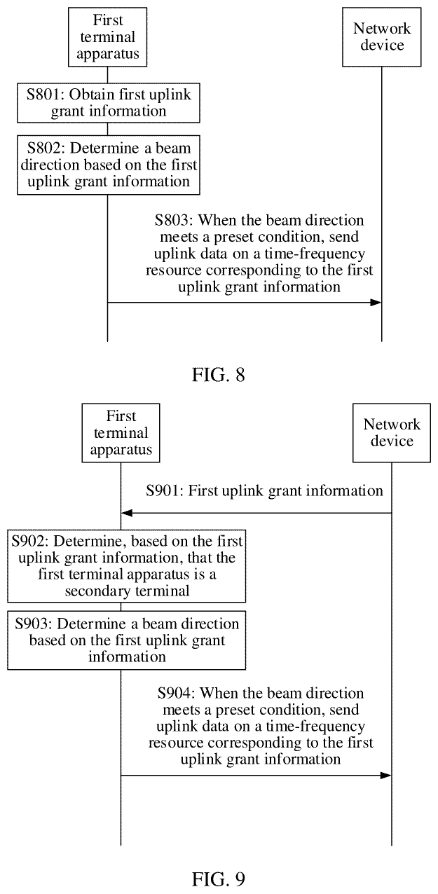

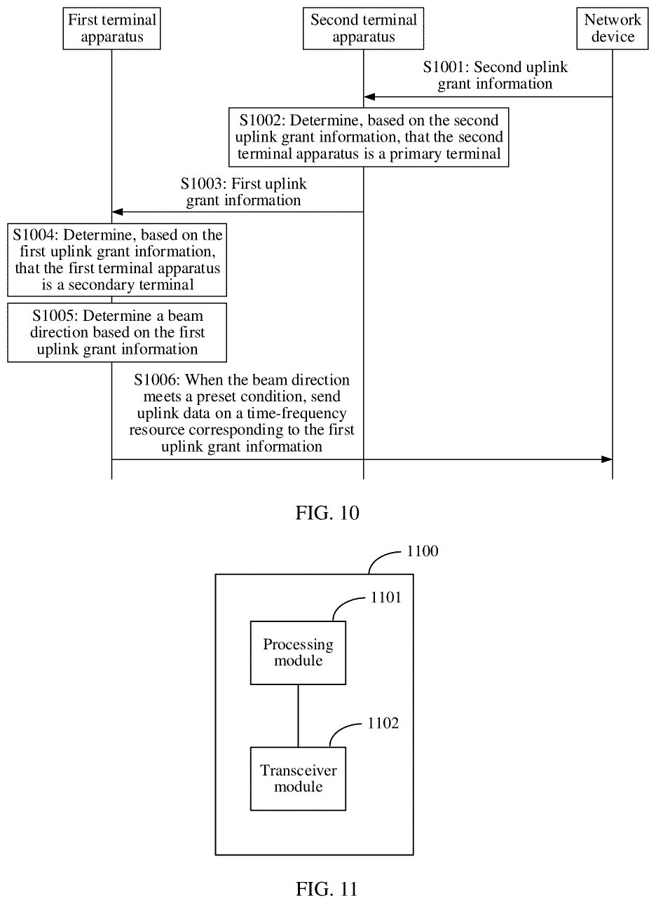

With reference to procedures shown in FIG. 9 and FIG. 10, the following describes the data transmission method provided in embodiments of this disclosure by using an example. FIG. 9 corresponds to the first implementation in S801, and FIG. 10 corresponds to the second implementation in S801.

An embodiment shown in FIG. 9 may include the following steps.

S901: A network device determines and sends first uplink grant information.

Correspondingly, a first terminal apparatus receives the first uplink grant information.

S901 corresponds to S801. As described in S801, a time-frequency resource corresponding to the first uplink grant information may be allocated by the network device to a second terminal apparatus, in other words, the second terminal apparatus may be a primary terminal. In addition, the first terminal apparatus and the second terminal apparatus may alternatively be used as secondary terminals. For example, there is no primary terminal. The first uplink grant information may be carried on a PDCCH, in other words, the first uplink grant information is DCI. In this case, an RNTI used by the first terminal apparatus to receive the first uplink grant information may be pre-configured by a base station by using signaling, or may be calculated by the first terminal apparatus based on a resource such as a time domain resource, a frequency domain resource, a code domain resource, or a multiple access signature. For details, refer to the descriptions of S801.

In some embodiments, if the second terminal apparatus is the primary terminal, the first uplink grant information may include information about the primary terminal and/or information about the secondary terminal. The information about the primary terminal may include information indicating the primary terminal (for example, an identifier of the primary terminal), and indication information of a transmission resource and/or a transmission parameter of the primary terminal. For the information about the primary terminal and the indication information of the transmission resource and/or the transmission parameter of the primary terminal, refer to the descriptions in S801. Details are not described herein again. The information about the secondary terminal may include information indicating the secondary terminal (for example, an identifier of the secondary terminal), indication information of a beam direction, indication information indicating whether the first terminal apparatus (or the secondary terminal) is allowed to perform uplink transmission by using the first uplink grant information (or the time-frequency resource), or indication information of a transmission resource and/or a transmission parameter of the secondary terminal. For details, refer to the descriptions in S801.

In some embodiments, if the second terminal apparatus is the secondary terminal, in other words, there is no primary terminal, the first uplink grant information may include information indicating the secondary terminal (for example, an identifier of the secondary terminal), indication information of a beam direction, indication information indicating whether the first terminal apparatus (or the secondary terminal) is allowed to perform uplink transmission by using the first uplink grant information (or the time-frequency resource), or indication information of a transmission resource and/or a transmission parameter of the secondary terminal. For details, refer to the descriptions in S801. For example, the secondary terminal herein includes the first terminal apparatus and the second terminal apparatus.

S902: The first terminal apparatus determines, based on the first uplink grant information, that the first terminal apparatus is the secondary terminal.

This step is an optional step.

Optionally, the first terminal apparatus may determine, based on the first uplink grant information, that a terminal type of the first terminal apparatus is the secondary terminal, and then perform corresponding processing of the secondary terminal. The corresponding processing of the secondary terminal is S903 and S904, or S802 and S803. Further, optionally, as described in S801, the first uplink grant information may include the identifier of the secondary terminal or the identifier of the primary terminal. In this case, the first terminal apparatus may identify, based on the identifier of the secondary terminal or the identifier of the primary terminal in the first uplink grant information, that the first terminal apparatus is the secondary terminal.

When the first uplink grant information includes only the identifier of the primary terminal, if the first terminal apparatus determines that an identifier of the first terminal apparatus is different from the identifier of the primary terminal, in some embodiments, the first terminal apparatus determines that the first terminal apparatus is the secondary terminal. Similarly, when the first uplink grant information includes only the identifier of the secondary terminal, if the first terminal apparatus determines that the first terminal apparatus is not the secondary terminal, in some embodiments, the first terminal apparatus determines that the first terminal apparatus is the primary terminal.

Alternatively, optionally, there is a correspondence (which may be referred to as a fourth correspondence) between a terminal type (for example, the primary terminal and the secondary terminal) and at least one of an RNTI, a CORESET, search space, or a signaling format used to receive the first uplink grant information. As described in S801, the first terminal apparatus may determine, based on the at least one of the RNTI, the CORESET, the search space, or the signaling format used to receive the first uplink grant information, that the first terminal apparatus is the secondary terminal. For example, if the at least one of the RNTI, the CORESET, the search space, or the signaling format used by the first terminal apparatus to receive the first uplink grant information corresponds to the secondary terminal, the first terminal apparatus determines that the first terminal apparatus is the secondary terminal. In addition, if the at least one of the RNTI, the CORESET, the search space, or the signaling format used by the first terminal apparatus to receive the first uplink grant information corresponds to the primary terminal, the first terminal apparatus determines that the first terminal apparatus is the primary terminal.

In addition, if the first terminal apparatus (or the second terminal apparatus) determines, based on the first uplink grant information, that the first terminal apparatus (or the second terminal apparatus) is the primary terminal, S903 and S904 are ignored. In this case, the first terminal apparatus (or the second terminal apparatus) may perform uplink data transmission in a dynamic grant manner based on the time-frequency resource indicated by the first uplink grant information.

Optionally, the first uplink grant information may further include indication information indicating that the first terminal apparatus (or the secondary terminal) is allowed to perform uplink transmission by using the first uplink grant information (or the time-frequency resource). Otherwise, if the first uplink grant information does not include the indication information indicating that the first terminal apparatus (or the secondary terminal) is allowed to perform uplink transmission by using the first uplink grant information (or the time-frequency resource), or the first uplink grant information includes indication information indicating that the first terminal apparatus (or the secondary terminal) is not allowed to perform uplink transmission by using the first uplink grant information (or the time-frequency resource), the first terminal apparatus ignores performing S903 and S904.

S903: The first terminal apparatus determines the beam direction based on the first uplink grant information.

S903 corresponds to S802. Therefore, for S903, refer to the descriptions in S802.

S904: When the beam direction meets a preset condition, the first terminal apparatus sends uplink data on the time-frequency resource corresponding to the first uplink grant information. Alternatively, when the beam direction does not meet a preset condition, the first terminal apparatus skips sending uplink data on the time-frequency resource corresponding to the first uplink grant information.

S904 corresponds to S803. Therefore, for S904, refer to the descriptions in S803.

Based on the embodiment shown in FIG. 9, the first terminal apparatus may receive the first uplink grant information sent by the network device, where the first uplink grant information may schedule uplink transmission of the second terminal apparatus. For example, before S901, the method may further include the following step: The second terminal apparatus may send a scheduling request to the network device through a PUCCH, or the second terminal apparatus may send a buffer state to the network device through a PUSCH. Therefore, in S901, the network device sends the first uplink grant information in response to the scheduling request or the buffer state from the second terminal apparatus, where the first uplink grant information includes the time-frequency resource allocated by the network device for uplink transmission of the second terminal apparatus. In this case, the second terminal apparatus is a primary terminal of the first uplink grant information, or is referred to as a primary terminal. Based on FIG. 9, when the beam direction meets the preset condition, the first terminal apparatus may send the uplink data based on the time-frequency resource corresponding to the first uplink grant information, where the time-frequency resource and a corresponding beam are allocated by the network device to the second terminal apparatus. Therefore, the network device does not need to allocate a transmission resource (for example, a grant-free resource) to each terminal, so that a quantity of terminal devices that perform multiplexing transmission on a same time-frequency resource can be increased, thereby improving a multiplexing capability of a communication system. In addition, it is not excluded that the second terminal apparatus is used as a secondary terminal, and may be configured to request an uplink grant from the network device.

In some embodiments, when receiving the first uplink grant information, the first terminal apparatus may directly send the uplink data by using the time-frequency resource corresponding to the first uplink grant information, and does not need to perform an action of determining the beam direction in S903 or an action of determining whether the beam direction meets the preset condition in S904. For example, the network device configures the first terminal apparatus to receive the first uplink grant information only when the first terminal apparatus and the second terminal apparatus have a same beam direction. In this case, when the first terminal apparatus can receive the first uplink grant information, the first terminal apparatus may send the uplink data by using the corresponding time-frequency resource by default.

An embodiment shown in FIG. 10 may include the following steps.

S1001: A network device determines and sends second uplink grant information.

Correspondingly, a second terminal apparatus receives the second uplink grant information.

A time-frequency resource corresponding to the second uplink grant information may be allocated by the network device to the second terminal apparatus, in other words, the second terminal apparatus may be a primary terminal. In addition, a first terminal apparatus and the second terminal apparatus may alternatively be used as secondary terminals. For example, there is no primary terminal. The second uplink grant information may be carried on a PDCCH, in other words, the second uplink grant information is DCI. Optionally, an RNTI used by the second terminal apparatus to receive the second uplink grant information may be pre-configured by a base station by using signaling.

In some embodiments, if the second terminal apparatus is the primary terminal, the second uplink grant information may include information used to identify a terminal type, for example, information about the primary terminal and information about the secondary terminal. The information about the primary terminal may include information indicating the primary terminal (for example, an identifier of the primary terminal), and indication information of a transmission resource and/or a transmission parameter of the primary terminal. For the information used to identify the terminal type, and the indication information of the transmission resource and/or the transmission parameter of the primary terminal, refer to the descriptions in S801. Details are not described herein again. The information about the secondary terminal may include information indicating the secondary terminal (for example, an identifier of the secondary terminal), indication information of a beam direction, indication information indicating whether the first terminal apparatus (or the secondary terminal) is allowed to perform uplink transmission by using the time-frequency resource, or indication information of a transmission resource and/or a transmission parameter of the secondary terminal. For details, refer to the descriptions in S801.

In some embodiments, if the second terminal apparatus is the secondary terminal, in other words, there is no primary terminal, the second uplink grant information may include information indicating the secondary terminal (for example, an identifier of the secondary terminal), indication information of a beam direction, indication information indicating whether the first terminal apparatus (or the secondary terminal) is allowed to perform uplink transmission by using the time-frequency resource, or indication information of a transmission resource and/or a transmission parameter of the secondary terminal. For details, refer to the descriptions in S801. For example, the secondary terminal herein includes the first terminal apparatus and the second terminal apparatus.

S1002: The second terminal apparatus determines, based on the second uplink grant information, that the second terminal apparatus is the primary terminal.

This step is an optional step. The second terminal apparatus may determine, based on the second uplink grant information, that a terminal type of the second terminal apparatus is the primary terminal, and then perform corresponding processing of the primary terminal, where the corresponding processing of the primary terminal is S1003. Further, optionally, the second uplink grant information may include the identifier of the secondary terminal or the identifier of the primary terminal. In this case, the second terminal apparatus may identify, based on the identifier of the secondary terminal or the identifier of the primary terminal in the second uplink grant information, that the second terminal apparatus is the primary terminal. For a meaning and a usage manner of the identifier of the secondary terminal or the identifier of the primary terminal, refer to the descriptions in S801. Optionally, there is a correspondence (namely, a fourth correspondence) between the terminal type (for example, the primary terminal and the secondary terminal) and at least one of an RNTI, a CORESET, search space, or a signaling format used to receive the second uplink grant information. The second terminal apparatus may determine, based on the correspondence and the at least one of the RNTI, the CORESET, the search space, or the signaling format used to receive the second uplink grant information, that the second terminal apparatus is the primary terminal or the secondary terminal.

In addition, if the second terminal apparatus determines, based on the second uplink grant information, that the second terminal apparatus is the secondary terminal, S1003 is ignored. Optionally, in this case, the second terminal apparatus may perform S903 and S904.

Optionally, after determining that the second terminal apparatus is the primary terminal, the second terminal apparatus may send uplink data on the time-frequency resource corresponding to the second uplink grant information.

S1003: The second terminal apparatus sends first uplink grant information to the first terminal apparatus.

Correspondingly, the first terminal apparatus receives the first uplink grant information.

Optionally, the second terminal apparatus may forward the second uplink grant information as the first uplink grant information to the first terminal apparatus, or the second terminal apparatus may determine the first uplink grant information based on the second uplink grant information, and send the first uplink grant information to the first terminal apparatus.

The first uplink grant information is determined based on the second uplink grant information. For example, the first uplink grant information includes at least one of a transmission resource, a beam direction, a transmission parameter, a terminal type, indication information of the transmission resource, indication information of the beam direction, indication information of the transmission parameter, or indication information (for example, including the identifier of the primary terminal and/or the identifier of the secondary terminal) of the terminal type. The at least one of the transmission resource, the beam direction, the transmission parameter, the terminal type, the indication information of the transmission resource, the indication information of the beam direction, the indication information of the transmission parameter, or the indication information of the terminal type may be carried in the second uplink grant information. Alternatively, the second terminal apparatus may determine at least one of the transmission resource, the beam direction, the transmission parameter, or the terminal type based on the at least one of the RNTI, the CORESET, the search space, or the signaling format used to receive the second uplink grant information, and include, in the first uplink grant information, the at least one of the transmission resource, the beam direction, the transmission parameter, the terminal type, the indication information of the transmission resource, the indication information of the beam direction, the indication information of the transmission parameter, or the indication information of the terminal type.

It may be understood that, for a manner in which the second terminal apparatus determines the at least one of the transmission resource, the beam direction, the transmission parameter, or the terminal type based on the at least one of the RNTI, the CORESET, the search space, or the signaling format used to receive the second uplink grant information, refer to the described manner in which the first terminal apparatus determines the at least one of the transmission resource, the beam direction, the transmission parameter, or the terminal type based on the at least one of the RNTI, the CORESET, the search space, or the signaling format used to receive the first uplink grant information in S801. For example, the network device indicates a correspondence between the at least one of the RNTI, the CORESET, the search space, or the signaling format and at least one of the transmission resource, the beam direction, or the transmission parameter to the second terminal apparatus by using an RRC message, a MAC CE, or DCI. If the correspondence includes a correspondence between an RNTI-1 and a transmission resource-1, after the second terminal apparatus receives the second uplink grant information based on the RNTI-1, the second terminal apparatus may determine that the transmission resource includes the transmission resource-1.

Optionally, the second terminal apparatus may send the first uplink grant information to the first terminal apparatus in a unicast, groupcast, or broadcast manner through a link such as a D2D link, a sidelink, or Bluetooth between the second terminal apparatus and the first terminal apparatus. For example, the first uplink grant information may be carried on a PSCCH or a PSSCH.

Optionally, the second uplink grant information may further include indication information indicating that the first terminal apparatus (or the secondary terminal) is allowed to perform uplink transmission by using the first uplink grant information (or a time-frequency resource). Otherwise, if the second uplink grant information does not include the indication information indicating that the first terminal apparatus (or the secondary terminal) is allowed to perform uplink transmission by using the first uplink grant information (or the time-frequency resource), or the second uplink grant information includes indication information indicating that the first terminal apparatus (or the secondary terminal) is not allowed to perform uplink transmission by using the first uplink grant information (or the time-frequency resource), the first terminal apparatus ignores performing S1004 to S1006.

S1004: The first terminal apparatus determines, based on the first uplink grant information, that the first terminal apparatus is the secondary terminal.

This step is an optional step. The first terminal apparatus may determine, based on

indication information of a terminal type included in the first uplink grant information, that the first terminal apparatus is the secondary terminal. For example, the indication information of the terminal type includes the identifier of the primary terminal and/or the identifier of the secondary terminal, and when the identifier of the primary terminal does not include an identifier of the first terminal apparatus, or when the identifier of the secondary terminal includes the identifier of the first terminal apparatus, the first terminal apparatus may determine that the first terminal apparatus is the secondary terminal.

The indication information of the terminal type may be included in the first uplink grant information.

S1005: The first terminal apparatus determines the beam direction based on the first uplink grant information.

S1005 corresponds to S802. Therefore, for S1005, refer to the descriptions in S802.

S1006: When the beam direction meets a preset condition, the first terminal apparatus sends uplink data on the time-frequency resource corresponding to the first uplink grant information. Alternatively, when the beam direction does not meet a preset condition, the first terminal apparatus skips sending uplink data on the time-frequency resource corresponding to the first uplink grant information.

S1006 corresponds to S803. Therefore, for S1006, refer to the descriptions in S803.

Based on the embodiment shown in FIG. 10, the second terminal apparatus may receive the second uplink grant information sent by the network device, and send the first uplink grant information to the first terminal apparatus based on the second uplink grant information. For example, before S1001, the method may further include the following step: The second terminal apparatus may send a scheduling request to the network device through a PUCCH, or the second terminal apparatus may send a buffer state to the network device through a PUSCH. Therefore, in S1001, the network device sends the second uplink grant information in response to the scheduling request or the buffer state from the second terminal apparatus, where the second uplink grant information includes the time-frequency resource allocated by the network device for uplink transmission of the second terminal apparatus. In this case, the second terminal apparatus is a primary terminal of the second uplink grant information, or is referred to as a primary terminal. In some embodiments, when receiving the first uplink grant information, the first

terminal apparatus may directly send the uplink data by using the time-frequency resource corresponding to the first uplink grant information, and does not need to perform an action of determining the beam direction in S1005 or an action of determining whether the beam direction meets the preset condition in S1006. For example, the network device configures the first terminal apparatus to receive the first uplink grant information only when the first terminal apparatus and the second terminal apparatus have a same beam direction. In this case, when the first terminal apparatus can receive the first uplink grant information, the first terminal apparatus may send the uplink data by using the corresponding time-frequency resource by default.

Based on the method in FIG. 8, FIG. 9, or FIG. 10, when the beam direction meets the preset condition, the first terminal apparatus may send the uplink data based on the time-frequency resource corresponding to the first uplink grant information, where the time-frequency resource is allocated by the network device to the second terminal apparatus. According to the method, when there is a proper transmission opportunity, even if the transmission opportunity is not specially allocated by the network device to the first terminal apparatus, the first terminal apparatus may still use the transmission opportunity to implement opportunistic access and data transmission. In some scenarios, the network device does not need to allocate a transmission resource (for example, a grant-free resource) to each terminal, so that a quantity of terminal devices that perform multiplexing transmission on a same time-frequency resource can be increased, thereby improving a multiplexing capability of a communication system.

The foregoing describes the method provided in embodiments of this disclosure. To implement functions in the method provided in the foregoing embodiments of this disclosure, a communication apparatus may include a hardware structure and/or a software module, to implement the foregoing functions by using the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

As shown in FIG. 11, based on a same technical concept, an embodiment of this disclosure further provides a data transmission apparatus 1100. The data transmission apparatus 1100 may be a data transmission apparatus, an apparatus or a component in the data transmission apparatus, or an apparatus that can be used together with the data transmission apparatus. The data transmission apparatus 1100 may be a terminal device or a network device. In a design, the data transmission apparatus 1100 may include modules that are in one-to-one correspondence with the methods/operations/steps/actions in the foregoing method embodiments. The modules may be hardware circuits or software, or may be implemented by a combination of the hardware circuits and the software. In a design, the data transmission apparatus 1100 may include a processing module 1101 and a transceiver module 1102. The transceiver module 1102 may include a sending module and/or a receiving module.

For example, when the apparatus is configured to perform the method that is performed by the first terminal apparatus and that is described in the foregoing embodiments, the apparatus may include a transceiver module 1102 and a processing module 1101. The transceiver module 1102 may be configured to receive first uplink grant information. The processing module 1101 may be configured to determine a beam direction based on the first uplink grant information. The transceiver module 1102 may be further configured to: when the beam direction meets a preset condition, send uplink data on a time-frequency resource. For the first uplink grant information, refer to the descriptions in the foregoing method embodiments.

Optionally, the transceiver module 1102 may be further configured to: when the beam direction does not meet the preset condition, skip sending the uplink data on the time-frequency resource. For the preset condition, refer to the descriptions in the foregoing method embodiments.

In addition, optionally, the transceiver module 1102 may be configured to receive the first uplink grant information from a network device or a second terminal apparatus.

Optionally, when the first uplink grant information includes indication information of a reference signal associated with the beam direction or a beam direction identifier, the processing module 1101 may further determine the beam direction based on the indication information of the reference signal or the beam direction identifier. Alternatively, the processing module 1101 may further determine the beam direction based on at least one of a radio network temporary identifier (RNTI), a control-resource set (CORESET), search space, or a signaling format used to receive the first uplink grant information.

Optionally, the processing module 1101 may further determine a transmission resource and/or a transmission parameter based on the at least one of the RNTI, the CORESET, the search space, or the signaling format used to receive the first uplink grant information, where the transmission resource and/or the transmission parameter are/is used by the first terminal apparatus to send the uplink data, and the transmission resource includes the time-frequency resource.

For example, when the apparatus is configured to perform the method that is performed by the second terminal apparatus and that is described in the foregoing embodiments, the apparatus may include a transceiver module 1102 and a processing module 1101. The transceiver module 1102 may be configured to receive second uplink grant information from a network device, and may be further configured to send first uplink grant information to a first terminal apparatus based on the second uplink grant information. Optionally, the processing module 1101 may be configured to generate the first uplink grant information based on the second uplink grant information. In addition, the processing module 1101 may be configured to parse a radio signal, to obtain the second uplink grant information from the network device. Therefore, in other words, the processing module 1101 may be configured to obtain the second uplink grant information. For the first uplink grant information and the second uplink grant information, refer to the descriptions in the foregoing method embodiments.

For example, when the apparatus is configured to perform the method that is performed by the network device and that is described in the foregoing embodiments, the apparatus may include a transceiver module 1102 and a processing module 1101. The processing module 1101 may be configured to determine first uplink grant information, and the transceiver module 1102 may be configured to send the first uplink grant information. For the first uplink grant information, refer to the descriptions of the first uplink grant information in the foregoing method embodiments.

The transceiver module 1102 may be further configured to perform actions represented by arrows in the embodiments shown in FIG. 8 to FIG. 10, and the processing module 1101 is further configured to perform other operations in actions represented by rectangular boxes in the embodiments shown in FIG. 8 to FIG. 10. Details are not described herein again.

Division into modules in embodiments of this disclosure is an example, is merely division into logical functions, and may be other division during actual implementation. In addition, function modules in embodiments of this disclosure may be integrated into one processor, or each of the modules may exist alone physically, or two or more modules may be integrated into one module. The integrated module may be implemented in a form of hardware, or may be implemented in a form of a software function module.

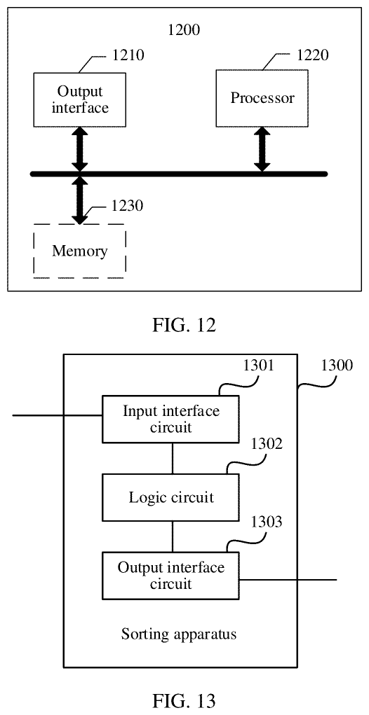

FIG. 12 shows a data transmission apparatus 1200 according to an embodiment of this disclosure. The data transmission apparatus 1200 is configured to implement the data transmission method provided in this disclosure. The data transmission apparatus 1200 may be an apparatus or a component located in a terminal device, may be a terminal device, or may be a network device or an apparatus or a component in the network device. The data transmission apparatus 1200 may be a data transmission apparatus, may be an apparatus in the data transmission apparatus, or may be an apparatus that can be used together with the data transmission apparatus. The data transmission apparatus 1200 may be a chip system or a chip. In this embodiment of this disclosure, the chip system may include a chip, or may include a chip and another discrete component. The data transmission apparatus 1200 includes at least one processor 1220, configured to implement the data transmission method provided in embodiments of this disclosure. The data transmission apparatus 1200 may further include an output interface 1210, and the output interface may also be referred to as an input/output interface. In this embodiment of this disclosure, the communication interface is configured to communicate with another apparatus by using a transmission medium.

For example, when the data transmission apparatus 1200 is a chip, the data transmission apparatus 1200 performs transmission with another chip or component through the output interface 1210. The processor 1220 is configured to implement the method described in the foregoing method embodiments.

For example, when the apparatus is configured to perform the method that is performed by the first terminal apparatus and that is described in the foregoing embodiments, the apparatus may include an output interface 1210 and a processor 1220. The output interface 1210 may be configured to receive first uplink grant information. The processor 1220 may be configured to determine a beam direction based on the first uplink grant information. The output interface 1210 may be further configured to: when the beam direction meets a preset condition, send uplink data on a time-frequency resource. For the first uplink grant information, refer to the descriptions in the foregoing method embodiments.

Optionally, the output interface 1210 may be further configured to: when the beam direction does not meet the preset condition, skip sending the uplink data on the time-frequency resource. For the preset condition, refer to the descriptions in the foregoing method embodiments.

In addition, optionally, the output interface 1210 may be configured to receive the first uplink grant information from a network device or a second terminal apparatus.

Optionally, when the first uplink grant information includes indication information of a reference signal associated with the beam direction or a beam direction identifier, the processor 1220 may further determine the beam direction based on the indication information of the reference signal or the beam direction identifier. Alternatively, the processor 1220 may further determine the beam direction based on at least one of a radio network temporary identifier (RNTI), a control-resource set (CORESET), search space, or a signaling format used to receive the first uplink grant information.

Optionally, the processor 1220 may further determine a transmission resource and/or a transmission parameter based on the at least one of the RNTI, the CORESET, the search space, or the signaling format used to receive the first uplink grant information, where the transmission resource and/or the transmission parameter are/is used by the first terminal apparatus to send the uplink data, and the transmission resource includes the time-frequency resource.

For example, when the apparatus is configured to perform the method that is performed by the second terminal apparatus and that is described in the foregoing embodiments, the apparatus may include an output interface 1210 and a processor 1220. The output interface 1210 may be configured to receive second uplink grant information from a network device, and may be further configured to send first uplink grant information to a first terminal apparatus based on the second uplink grant information. Optionally, the processor 1220 may be configured to generate the first uplink grant information based on the second uplink grant information. For the first uplink grant information and the second uplink grant information, refer to the descriptions in the foregoing method embodiments.

For example, when the apparatus is configured to perform the method that is performed by the network device and that is described in the foregoing embodiments, the apparatus may include an output interface 1210 and a processor 1220. The processor 1220 may be configured to determine first uplink grant information, and the output interface 1210 may be configured to send the first uplink grant information. For the first uplink grant information, refer to the descriptions in the foregoing method embodiments.

The output interface 1210 may be further configured to perform actions represented by arrows in the embodiments shown in FIG. 8 to FIG. 10, and the processor 1220 is further configured to perform other operations in actions represented by rectangular boxes in the embodiments shown in FIG. 8 to FIG. 10. Details are not described herein again.

The data transmission apparatus 1200 may further include at least one memory 1230, configured to store program instructions and/or data. The memory 1230 is coupled to the processor 1220. The coupling in this embodiment of this disclosure may be an indirect coupling or a communication connection between apparatuses, units, or modules in an electrical form, a mechanical form, or another form, and is used for information exchange between the apparatuses, the units, or the modules. The processor 1220 may cooperate with the memory 1230. The processor 1220 may execute the program instructions stored in the memory 1230. At least one of the at least one memory may be integrated with the processor.

In this embodiment of this disclosure, the memory 1230 may be a non-volatile memory, for example, a hard disk drive (HDD) or a solid-state drive (SSD), or may be a volatile memory, for example, a random-access memory (RAM). The memory is any other medium that can carry or store expected program code in a form of an instruction or a data structure and that can be accessed by a computer, but is not limited thereto. The memory in this embodiment of this disclosure may alternatively be a circuit or any other apparatus that can implement a storage function, and is configured to store the program instructions and/or the data.

In this embodiment of this disclosure, the processor 1220 may be a general-purpose processor, a digital signal processor, an application-specific integrated circuit, a field programmable gate array or another programmable logic device, a discrete gate or transistor logic device, or a discrete hardware component, and may implement or perform the methods, steps, and logical block diagrams disclosed in embodiments of this disclosure. The general-purpose processor may be a microprocessor, any conventional processor, or the like. The steps of the method disclosed with reference to embodiments of this disclosure may be directly performed by a hardware processor, or may be performed by using a combination of hardware and a software module in the processor.

FIG. 13 shows a data transmission apparatus 1300 according to an embodiment of this disclosure. The data transmission apparatus 1300 is configured to implement the data transmission method provided in this disclosure. The data transmission apparatus 1300 may be an apparatus located in a terminal device, may be a terminal device, or may be a network device or an apparatus or a component located in the network device. The data transmission apparatus 1300 may be a data transmission apparatus, may be an apparatus in the data transmission apparatus, or may be an apparatus that can be used together with the data transmission apparatus. The data transmission apparatus 1300 may be a chip system or a chip. In this embodiment of this disclosure, the chip system may include a chip, or may include a chip and another discrete component. A part or all of the data transmission method provided in the foregoing embodiments may be implemented by hardware or software. When the data transmission method is implemented by hardware, the data transmission apparatus 1300 may include an input interface circuit 1301, a logic circuit 1302, and an output interface circuit 1303. Optionally, that the apparatus is configured to implement a function of a first terminal apparatus is used as an example. The input interface circuit 1301 may be configured to obtain first uplink grant information, the logic circuit 1302 may be configured to perform a processing action of the first terminal apparatus, and the output interface circuit 1303 may be configured to output uplink data.

Optionally, during specific implementation, the data transmission apparatus 1300 may be a chip or an integrated circuit.

Some or all of operations and functions performed by the data transmission apparatus described in the foregoing method embodiments of this disclosure may be implemented by using the chip or the integrated circuit.

An embodiment of this disclosure provides a computer-readable storage medium storing a computer program. The computer program includes instructions for performing the foregoing method embodiments.

An embodiment of this disclosure provides a computer program product including instructions. When the computer program product runs on a computer, the computer is enabled to perform the foregoing method embodiments.

Persons skilled in the art should understand that embodiments of this disclosure may be provided as a method, a system, or a computer program product. Therefore, this disclosure may use a form of hardware only embodiments, software only embodiments, or embodiments with a combination of software and hardware. In addition, this disclosure may use a form of a computer program product implemented on one or more computer-usable storage media (including but not limited to a disk memory, a CD-ROM, an optical memory, and the like) that include computer-usable program code.

This disclosure is described with reference to the flowcharts and/or block diagrams of the method, the device (system), and the computer program product according to embodiments of this disclosure. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

The computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the block diagrams.

Although embodiments of this disclosure are described, persons skilled in the art can make changes and modifications to these embodiments after they learn of a basic inventive concept.

Therefore, the appended claims are intended to be construed as to cover the embodiments and all changes and modifications falling within the scope of this disclosure.

Apparently, persons skilled in the art may make various modifications and variations to embodiments of this disclosure without departing from the scope of embodiments of this disclosure. In this case, this disclosure is intended to cover these modifications and variations of embodiments of this disclosure provided that they fall within the scope of protection defined by the following claims and their equivalent technologies.

What is claimed is:

1. A method, wherein the method is applicable to a first terminal apparatus and the method comprises:
receiving first uplink grant information, wherein a time-frequency resource corresponding to the first uplink grant information is used for uplink transmission of a second terminal apparatus;
determining, a beam direction based on the first uplink grant information; and
when the beam direction meets a preset condition, sending uplink data on the time-frequency resource.

2. The method according to claim 1, further comprising:
when the beam direction does not meet the preset condition, skipping sending the uplink data on the time-frequency resource.

3. The method according to claim 1, wherein the preset condition comprises at least one of:
a signal measurement value corresponding to the beam direction meets a threshold condition; and
a beam direction of the first terminal apparatus comprises the beam direction.

4. The method according to claim 1, wherein the receiving first uplink grant information comprises one or more of:
receiving the first uplink grant information from the second terminal apparatus; or
from a network side apparatus.

5. The method according to claim 1, wherein the first uplink grant information comprises information of a reference signal associated with the beam direction or a beam direction identifier.

6. The method according to claim 1, wherein the determining a beam direction based on the first uplink grant information comprises:
determining the beam direction based on at least one of a radio network temporary identifier (RNTI), a control-resource set (CORESET), search space, or a signaling format used to receive the first uplink grant information.

7. The method according to claim 1, wherein the first uplink grant information comprises one more of: information of a transmission resource, information of a transmission parameter, the transmission resource used by the first terminal apparatus to send the uplink data.

8. The method according to claim 7, wherein the transmission resource comprises the time-frequency resource.

9. The method according to claim 1, wherein the first uplink grant information is from a network side apparatus, the first uplink grant information comprises information indicating that the first terminal apparatus is allowed to send the uplink data.

10. The method according to claim 1, wherein the first uplink grant information is comprised in downlink control information (DCI).

11. The method according to claim 1, wherein the first uplink grant information is from the second terminal apparatus, the first uplink grant information comprises information associating with the determined beam direction.

12. The method according to claim 1, wherein the first uplink grant information is from the second terminal apparatus, the first uplink grant information comprises one or more of a reference signal associated with the determined beam direction or a beam direction identifier of the determined beam direction.

13. An apparatus comprising:
a processing circuit coupled with a memory, wherein the memory is configured to store one or more computer programs, and when the one or more computer programs runs on the apparatus, causes the apparatus to:
receive first uplink grant information, wherein a time-frequency resource corresponding to the first uplink grant information is used for uplink transmission of a terminal apparatus;
determine, a beam direction based on the first uplink grant information; and
send uplink data on the time-frequency resource when the beam direction meets a preset condition.

14. The apparatus according to claim 13, further cause the apparatus to:
skipping sending the uplink data on the time-frequency resource when the beam direction does not meet the preset condition.

15. The apparatus according to claim 13, wherein the preset condition comprises at least one of:
a signal measurement value corresponding to the beam direction meets a threshold condition; and
a beam direction of the apparatus comprises the beam direction.

16. The apparatus according to claim 13, wherein the first uplink grant information is from one or more of:
the terminal apparatus; or
a network side apparatus.

17. The apparatus according to claim 13, wherein the first uplink grant information comprises information of a reference signal associated with the determined beam direction or a beam direction identifier of the determined beam direction.

18. The apparatus according to claim 13, wherein the determined beam direction is associated with at least one of a radio network temporary identifier (RNTI), a control-resource set (CORESET), search space, or a signaling format used to receive the first uplink grant information.

19. The apparatus according to claim 13, wherein the first uplink grant information comprises one more of: information of a transmission resource, information of a transmission parameter, the transmission resource used by the apparatus to send the uplink data.

20. A non-transitory computer readable storage medium, wherein the computer readable storage medium is configured to store a computer program, and when the computer program is run on a computer, cause the computer to:
receive first uplink grant information, wherein a time-frequency resource corresponding to the first uplink grant information is used for uplink transmission of a terminal apparatus;
determine, a beam direction based on the first uplink grant information; and
send uplink data on the time-frequency resource when the beam direction meets a preset condition.
